(19) United States
(12) Patent Application Publication
(10) Pub. No.: US 2018/0245573 A1
(43) Pub. Date: Aug. 30, 2018

(54) Hydraulic Control Apparatus and Brake System

(71) Applicant: Hitachi Automotive Systems, Ltd., Hitachinaka-shi, Ibaraki (JP)

(72) Inventors: Ryohei MARUO, Kawasaki-shi, Kanagawa (JP); Chiharu NAKAZAWA, Kawasaki-shi, Kanagawa (JP)

(73) Assignee: Hitachi Automotive Systems, Ltd.

(21) Appl. No.: 15/758,614

(22) PCT Filed: Aug. 2, 2016
(86) PCT No.: PCT/JP2016/072613

§ 371 Date: Mar. 8, 2018

(30) Foreign Application Priority Data
Sep. 30, 2015 (JP) 2015-194418

(51) Int. Cl. F04B 1/04; B60T 13/14; B60T 8/36; B60T 8/40

(52) U.S. Cl. CPC F04B 1/0404; B60T 13/146; B60T 8/4031; B60T 8/4086; B60T 8/4022; B60T 8/3685

(57) ABSTRACT

An object of the present invention is to provide a hydraulic control apparatus capable of further effectively preventing or reducing a vibration. A second unit includes a housing including fluid passages and the like provided therein and configured to be mounted on a vehicle, a rotational driving shaft provided inside the housing, and a plurality of pump portions configured to be activated by a rotation of the rotational driving shaft and disposed in a direction around a central axis of the rotational driving shaft inside the housing. The pump portions are provided in such a manner that the number of pump portions positioned on a vertically lower side is larger than the number of pump portions positioned on a vertically upper side with respect to the central axis of the rotational driving shaft with the housing mounted on the vehicle.

### TECHNICAL FIELD

The present invention relates to a hydraulic control apparatus.

### BACKGROUND ART

Conventionally, there has been known a hydraulic control apparatus including a plurality of plunger pumps (for example, PTL 1).

### CITATION LIST

### Patent Literature

PTL 1: US Patent Application Public Disclosure No. 2013/0145758

### SUMMARY OF INVENTION

### Technical Problem

One of objects of the present invention is to provide a hydraulic control apparatus capable of further effectively damping a vibration.

### Solution to Problem

According to one aspect of the present invention, a hydraulic control apparatus is configured in such a manner that the number of plunger pumps positioned on a vertically lower side is larger than the number of plunger pumps positioned on a vertically upper side with respect to a central axis of a rotational driving shaft in a state mounted on a vehicle.

Therefore, the hydraulic control apparatus according to the one aspect of the present invention can further effectively damp the vibration.

### BRIEF DESCRIPTION OF DRAWINGS

FIG. 1 is a perspective view of a part of a brake system according to a first embodiment.

FIG. 2 illustrates a schematic configuration of the brake system according to the first embodiment.

FIG. 3 is a perspective view of a second unit according to the first embodiment.

FIG. 4 is a front view of the second unit according to the first embodiment.

FIG. 5 is a side view of the second unit according to the first embodiment.

FIG. 6 is a top view of the second unit according to the first embodiment.

FIG. 7 is a cross-sectional view taken along a line VII-VII illustrated in FIG. 6.

FIG. 8 is a perspective view of the second unit with a pin or the like attached thereto according to the first embodiment.

FIG. 9 is a perspective view of the second unit set on a mount according to the first embodiment.

FIG. 10 is a front view (a cross-sectional view) of the second unit set on the mount according to the first embodiment.

FIG. 11 is a cross-sectional view taken along a line XI-XI illustrated in FIG. 10.

FIG. 12 is an exploded perspective view illustrating a process of attaching the second unit onto the mount according to the first embodiment.

FIG. 13 is a perspective view of a second unit with the pin and the like attached thereto according to a second embodiment.

FIG. 14 is a perspective view of the second unit set on the mount according to the second embodiment.

FIG. 15 is a front view (a cross-sectional view) of the second unit set on the mount according to the second embodiment.

FIG. 16 is an exploded perspective view illustrating a process of attaching the second unit onto the mount according to the second embodiment.

### DESCRIPTION OF EMBODIMENTS

In the following description, embodiments for implementing the present invention will be described with reference to the drawings.

### First Embodiment

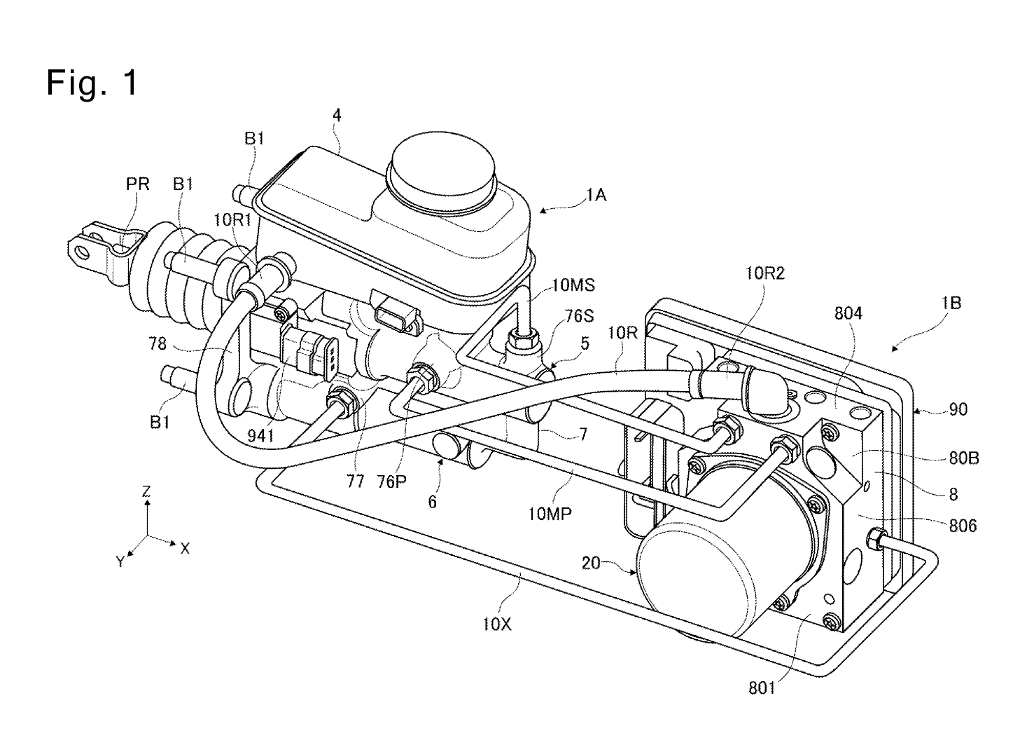

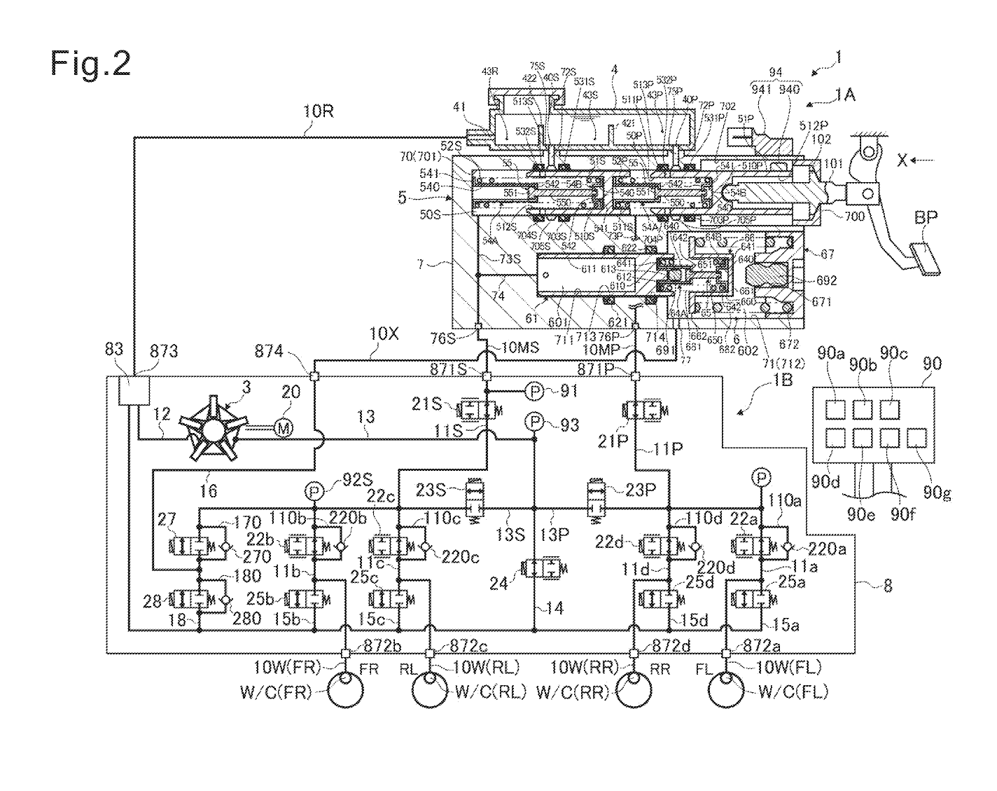

First, a configuration will be described. FIG. 1 illustrates an outer appearance of a part of a brake system 1 according to the present embodiment from an angle. FIG. 2 illustrates a schematic configuration of the brake system 1 together with a hydraulic circuit, and illustrates a cross section of a first unit 1A. The brake system 1 is usable for a hybrid automobile including an electric motor (a generator) in addition to an internal combustion engine, an electric automobile including only the electric motor, and the like, besides a general vehicle including only the internal combustion engine (an engine) as a prime mover that drives wheels. The brake system 1 is a hydraulic braking apparatus that provides a frictional braking force with use of a hydraulic pressure to each of wheels FL to RR of the vehicle. A brake actuation unit is provided on each of the wheels FL to RR. The brake actuation unit is, for example, a disk-type brake, and includes a wheel cylinder W/C and a caliper. The caliper includes a brake disk and brake pads. The brake disk is a brake rotor rotatable integrally with a tire. The brake pads are disposed with a predetermined clearance generated from the brake disk, and contact the brake disk by being moved by a hydraulic pressure in the wheel cylinder W/C. By this operation, the brake actuation unit generates the frictional braking force. The brake system 1 includes two brake pipes (a primary P system and a secondary S system). A brake pipe configuration is, for example, an X-split pipe configuration. The brake system 1 may employ another piping method, such as a front/rear split pipe configuration. Hereinafter, when a member provided in correspondence with the P system and a member provided in correspondence with the S system should be distinguished from each other, indices P and S will be added at the ends of the respective reference numerals. The brake system 1 supplies brake fluid as hydraulic fluid (hydraulic liquid) to each of the brake actuation units via a brake pipe, and generates the hydraulic pressure (a brake hydraulic pressure) in the wheel cylinder W/C. By this operation, the brake system 1 provides the hydraulic braking force to each of the wheels FL to RR.

The brake system 1 includes the first unit 1A and a second unit 1B. The wheel cylinder W/C on each of the wheels FL to RR and the second unit 1B are connected to each other via a wheel cylinder pipe 10W. The first unit 1A and the second unit 1B are set up in, for example, an engine room isolated from a driving compartment of the vehicle, and are connected to each other via a plurality of pipes. The plurality of pipes include master cylinder pipes 10M (a primary pipe 10MP and a secondary pipe 10MS), an intake pipe 10R, and a backpressure pipe 10X. Except for the intake pipe 10R, each of the pipes 10M, 10W, and 10X is a metallic brake pipe (a metallic pipe), and, in particular, a steel tube such as a double walled steel tube. Both ends of each of the pipes 10M, 10W, and 10X each include a male pipe joint processed by flared processing. The intake pipe 10R is a brake hose (a hose pipe) formed so as to become flexible from a material such as rubber. Ends of the intake pipe 10R are connected to a port 873 and the like via nipples 10R1 and 10R2. The nipples 10R1 and 10R2 are each a resin connection member having a tubular portion. Hereinafter, a three-dimensional orthogonal coordinate system having an X axis, a Y axis, and a Z axis is set for convenience of the description. A Z-axis direction is defined to be a vertical direction and a Z-axis positive direction side is defined to be an upper side in the vertical direction with the first unit 1A and the second unit 1B mounted on the vehicle. An X-axis direction is defined to be a longitudinal direction of the vehicle and an X-axis positive direction side is defined to be a front side of the vehicle. A Y-axis direction is defined to be a lateral direction of the vehicle.

A brake pedal 100 is a brake operation member that receives an input of a brake operation performed by an operator (a driver). A push rod PR is rotatably connected to the brake pedal 100. The push rod PR extends from an end on an X-axis negative direction side that is connected to the brake pedal 100 toward the X-axis positive direction side. The first unit 1A is a brake operation unit mechanically connected to the brake pedal 100, and is a master cylinder unit including a master cylinder 5. The first unit 1A includes a reservoir tank 4, a housing 7, the master cylinder 5, a stroke sensor 94, and a stroke simulator 6. The reservoir tank 4 is a brake fluid source storing the brake fluid therein, and is a low-pressure portion opened to an atmospheric pressure. Replenishment ports 40P and 40S, a supply port 41, a first partition wall 421, and a second partition wall 422 are provided in the reservoir tank 4. The partition walls 421 and 422 extend from a bottom portion of the reservoir tank 4 to a predetermined height, and partition a bottom portion side of the reservoir tank 4 into three chambers 43. The three chambers 43 include first chambers 43P and 43S, and a second chamber 43R. The replenishment ports 40P and 40S are opened to the first chambers 43P and 43S, respectively, and the supply port 41 is opened to the second chamber 43R. One end of the intake pipe 10R is connected to the supply port 41. The housing 7 contains (houses) the master cylinder 5 and the stroke simulator 6 therein. A rectangular plate-like flange portion 78 is provided at an end of the housing 7 on the X-axis negative direction side. Four corners of the flange portion 78 are fixed to a dash panel on a vehicle body side with use of bolts B1. The reservoir tank 4 is set on a Z-axis positive direction side of the housing 7.

A cylinder 70 for the master cylinder 5, a cylinder 71 for the stroke simulator 6, and a plurality of fluid passages (fluid passages) are formed inside the housing 7. The cylinder 70 for the master cylinder 5 has a bottomed cylindrical shape extending in the X-axis direction, and is closed and opened on an X-axis positive direction side and an X-axis negative direction side thereof, respectively. The cylinder 70 includes a small-diameter portion 701 and a large-diameter portion 702 on the X-axis positive direction side and the X-axis negative direction side thereof, respectively. The small-diameter portion 701 includes two seal grooves 703 and 704 and one port 705 for each of the P system and the S system. The seal grooves 703 and 704 and the port 705 each have an annular shape extending in a direction around a central axis of the cylinder 70. The port 705 is disposed between the two seal grooves 703 and 704. The cylinder 71 for the stroke simulator 6 is disposed on a Z-axis negative direction side of the cylinder 70. The cylinder 71 has a bottomed cylindrical shape extending in the X-axis direction, and is closed and opened on an X-axis positive direction side and an X-axis negative direction side thereof, respectively. The cylinder 71 includes a small-diameter portion 711 and a large-diameter portion 712 on the X-axis positive direction side and the X-axis negative direction side thereof, respectively. A first seal groove 713 and a second seal groove 714 are provided on an inner peripheral surface of the small-diameter portion 711 at a generally central position in the X-axis direction and an X-axis negative direction side thereof, respectively. The seal grooves 713 and 714 each have an annular shape extending in a direction around a central axis of the cylinder 71.

The plurality of fluid passages includes replenishment fluid passages 72, supply fluid passages 73, and a positive pressure fluid passage 74. A plurality of ports is formed inside the housing 7, and these ports are opened on an outer surface of the housing 7. The plurality of ports includes replenishment ports 75, supply ports 76, and a backpressure port 77. The replenishment fluid passages 72P and 72S extend from the replenishment ports 75P and 75S to be opened to the ports 705P and 705S, respectively. The supply fluid passages 73P and 76S extend from the small-diameter portion 701 of the cylinder 70 to be opened to the supply ports 76P and 76S, respectively. The positive pressure fluid passage 74 extends from an end of the small-diameter portion 711 in the X-axis positive direction to be connected to the supply fluid passage 73S. The replenishment ports 75P and 75S are connected to the replenishment ports 40P and 40S of the reservoir tank 4, respectively. One end of the primary pipe 10MP is connected to the supply port 76P. One end of the secondary pipe 10MS is connected to the supply port 76S. One end of the backpressure pipe 10X is connected to the backpressure port 77. More specifically, the pipe joint at the end of the primary pipe 10MP is fastened and fixed by being fitted in the supply port 76P and sandwiched between the supply port 76P and the housing 7 by a nut, by which the above-described end is connected to the supply port 76P. The opposite end of the primary pipe 10MP and both ends of the other metallic pipes 10MS, 10W, and 10X are also connected to the ports in a similar manner.

The master cylinder 5 is a first hydraulic source capable of supplying the hydraulic pressure to the wheel cylinder W/C, and is connected to the brake pedal 100 via the push rod RP and actuated according to an operation performed by the driver on the brake pedal 100. The master cylinder 5 includes pistons 51 axially movable according to the operation on the brake pedal 100. The pistons 51 are contained in the cylinder 70 and define hydraulic chambers 50. The master cylinder 5 is a tandem-type cylinder, and includes a primary piston 51P connected to the push rod RP and a secondary piston 51S configured as a free piston in series as the pistons 51. The stroke sensor 94 includes a magnet 940 and a sensor main body 941 (a Hall element or the like). The magnet 940 is provided on the primary piston 51P, and the sensor main body 941 is attached on the outer surface of the housing 7. The pistons 51P and 51S each have a bottomed cylindrical shape, and are movable in the X-axis direction along the inner peripheral surface of the small-diameter portion 701. The pistons 51 each include a first recessed portion 511 and a second recessed portion 512 sharing a common bottom portion formed by a partition wall 510. A hole 513 penetrates through a circumferential wall of the first recessed portion 511. The first recessed portion 511 is disposed on the X-axis positive direction side, and the second recessed portion 512 is disposed on the X-axis negative direction side. An X-axis positive direction side of the push rod RP is contained in the second recessed portion 512P of the primary piston 51P. A semi-spherically rounded end of the push rod RP in the X-axis positive direction is in abutment with the partition wall 510P. A flange portion PR1 is provided on the push rod PR. A movement of the push rod RP toward the X-axis negative direction side is regulated by abutment between a stopper portion 700 provided at an opening portion of the cylinder 70 (the large-diameter portion 702) and the flange portion PR1. In the small-diameter portion 701, a primary chamber 50P is defined between the primary piston 51P (the first recessed portion 511P) and the secondary piston 51S (the second recessed portion 512S), and a secondary chamber 50S is defined between the secondary piston 51S (the first recessed portion 5115) and an end of the small-diameter portion 701 in the X-axis positive direction. The supply fluid passages 73P and 73S are constantly opened to the individual chambers 50P and 50S, respectively.

A spring 52P, a first retainer member 54A, a second retainer member 54B, and a stopper member 55 are set in the primary chamber 50P. The retainer members 54 each include a cylindrical portion 540. A first flange portion 541 flares radially outwardly on one axial end side of the cylindrical portion 540, and a second flange portion 542 flares radially inwardly on an opposite axial end side of the cylindrical portion 540. The first flange portion 541 of the first retainer member 54A is set on the partition wall 510S, and the first flange portion 541 of the second retainer member 54B is set on the partition wall 510P. The stopper member 55 has a bolt-like shape including a shaft portion 550, and a head portion 551 thereof flares radially outwardly at an end of the shaft portion 550. An opposite end of the shaft portion 550 is fixed to the second flange portion 542 of the second retainer member 54B. The head portion 551 is contained on an inner peripheral side of the cylindrical portion 540 of the first retainer member 54A movably along an inner peripheral surface of the cylindrical portion 540. Detachment of the head portion 551 from the cylindrical portion 540 is regulated by abutment of the head portion 551 against the second flange portion 542. The spring 52P is a coil spring as an elastic member, and a return spring constantly biasing the primary piston 51P toward the X-axis negative direction side. An X-axis positive direction side of the spring 52P is fitted to the cylindrical portion 540 of the first retainer member 54A and held by the first retainer member 54A. An X-axis negative direction side of the spring 52P is fitted to the cylindrical portion 540 of the second retainer member 54B and held by the second retainer member 54B. The spring 52P is set in a pressed and compressed state between the first flange portion 541 of the first retainer member 54A (the partition wall 510S) and the first flange portion 541 of the second retainer member 54B (the partition wall 510P). A spring 52S, the first retainer member 54A, the second retainer member 54B, and the stopper member 55 are set in the secondary chamber 50S. The first flange portion 541 of the first retainer member 54A is set at an end of the small-diameter portion 701 in the X-axis positive direction, and the first flange portion 541 of the second retainer member 54B is set on the partition wall 510S. The spring 52S is an elastic member as a return spring constantly biasing the secondary piston 51S toward the X-axis negative direction side. The spring 52S is set in a pressed and compressed state between the first flange portion 541 of the first retainer member 54A (the end of the small-diameter portion 701 in the X-axis positive direction) and the first flange portion 541 of the second retainer member 54B (the partition wall 510S). A layout and configuration of the stopper member 55 and the like other than that are similar to the primary chamber 50P side.

Cup-like seal members 531 and 532 are set in the seal grooves 703 and 704, respectively. Lip portions of the seal members 531 and 532 are in sliding contact with outer peripheral surfaces of the pistons 51. The seal member 531P on the X-axis negative direction side on the primary side prevents or reduces a flow of the brake fluid directed from the X-axis positive direction side (the port 705P) toward the X-axis negative direction side (the large-diameter portion 702). The seal member 532P on the X-axis positive direction side prevents or reduces a flow of the brake fluid directed toward the X-axis negative direction side (the port 705P), and permits a flow of the brake fluid directed toward the X-axis positive direction side (the primary chamber 50P). The seal member 531S on the X-axis negative direction side on the secondary side prevents or reduces a flow of the brake fluid directed from the X-axis negative direction side (the primary chamber 50P) toward the X-axis positive direction side (the port 705S). The seal member 532S on the X-axis positive direction side prevents or reduces a flow of the brake fluid directed toward the X-axis negative direction side (the port 705S), and permits a flow of the brake fluid directed toward the X-axis positive direction side (the secondary chamber 50S). The holes 513 are each positioned between portions where both the seal members 531 and 532 (the lip portions) and the outer peripheral surface of the piston 51 are in contact with each other (one side closer to the seal member 532 on the X-axis positive direction side) in an initial state, in which both the pistons 51P and 51S are maximally displaced toward the X-axis negative direction side.

The stroke simulator 6 is activated according to the brake operation performed by the driver, and provides a reaction force and a stroke to the brake pedal 100. The stroke simulator 6 includes a piston 61, a first seal member 621, a second seal member 622, a first retainer member 64A, a second retainer member 64B, a third retainer member 66, a stopper member 65, a plug member 67, a first spring 681, a second spring 682, a first damper 691, and a second damper 692. The piston 61 has a bottomed cylindrical shape and is contained in the cylinder 71. The piston 61 includes a first recessed portion 611 opened on the X-axis positive direction side and a second recessed portion 612 opened on the X-axis negative direction side. A columnar protruding portion 613 is provided inside the second recessed portion 612. The protruding portion 613 protrudes from a wall portion 610 separating the first and second recessed portions 611 and 612 therebetween. The piston 61 is movable in the X-axis direction along the inner peripheral surface of the small-diameter portion 711. An inside of the cylinder 71 is partitioned and divided into two chambers by the piston 61. A positive pressure chamber 601 (a main chamber) as a first chamber is defined between an X-axis positive direction side (including an inner peripheral side of the first recessed portion 611) of the piston 61 and the small-diameter portion 711. A backpressure chamber 602 (a sub chamber) as a second chamber is defined between an X-axis negative direction side of the piston 61 and the large-diameter portion 712. Cup-like first and second seal members 621 and 622 are set in the first and second seal grooves 713 and 714, respectively. Lip portions of the seal members 621 and 622 are in sliding contact with an outer peripheral surface of the piston 61. The first seal member 621 prevents or reduces a flow of the brake fluid directed from the X-axis positive direction side (the positive pressure chamber 601) toward the X-axis negative direction side (the backpressure chamber 602). The second seal member 622 prevents or reduces a flow of the brake fluid directed from the X-axis negative direction side (the backpressure chamber 602) toward the X-axis positive direction side (the positive pressure chamber 601). The positive pressure chamber 601 and the backpressure chamber 602 are liquid-tightly separated from each other by the seal members 621 and 622. Each of the seal members 621 and 622 may be an X-ring, or may be configured in such a manner that two cup-like seal members are arranged and disposed so as to be able to prevent or reduce the flows of the brake fluid to both the positive pressure chamber 601 and the backpressure chamber 602. Further, in the present embodiment, the seal grooves 713 and 714 are provided to the small-diameter portion 711 of the cylinder 71 as a structure for setting the seal members 621 and 622 (the seal members 621 and 622 are configured as so-called rod seals), but the seal grooves may be instead provided to the piston 61 (the seal members 621 and 622 may be configured so-called piston seals).

The retainer members 64 and 66, the stopper member 65, the springs 681 and 682, and the dampers 691 and 692 are contained in the backpressure chamber 602. The third retainer member 66 has a bottomed cylindrical shape including a cylindrical portion 660 and a bottom portion 661, and a flange portion 662 flares radially outwardly on an opening side of the cylindrical portion 660. The first damper 691 is an elastic member such as rubber, and has a columnar shape. The second damper 692 is an elastic member such as rubber, and has a columnar shape narrowed at an axially central portion thereof. A plug member 67 closes the opening of the cylinder (the large-diameter portion 712). A bottomed cylindrical first recessed portion 671 and a bottomed annular second recessed portion 672 are provided on an X-axis positive direction side of the plug member 67. The second damper 692 is set in the first recessed portion 671. One axial end side of a cylindrical portion 640 of the first retainer member 64A is fitted to the protruding portion 613 of the piston 61. The first damper 691 is set in abutment with the protruding portion 613 on an inner peripheral side of the cylindrical portion 630. The second retainer member 64B is set on an inner peripheral side of the third retainer member 66 (the cylindrical portion 660) in such a manner that a flange portion 641 is brought into abutment with the bottom portion 641. The first and second springs 681 and 682 are each an elastic member as a return spring constantly biasing the piston 61 toward one side where the positive pressure chamber 601 is located (a direction for reducing a volume of the positive pressure chamber 601 and increasing a volume of the backpressure chamber 602). The first spring 681 is a coil spring small in diameter. The first spring 681 is set in a pressed and compressed state between an end surface of the piston 61 in the X-axis negative direction (the first flange portion 641 of the first retainer member 64A) and the first flange portion 641 of the second retainer member 64B (the bottom portion 661 of the third retainer member 66). The second spring 682 is a coil spring large in diameter that has a larger spring coefficient than the first spring 681. An X-axis positive direction side of the second spring 682 is fitted to the cylindrical portion 660 of the third retainer member 66 and held by the third retainer member 66. An X-axis negative direction side of the second spring 682 is contained in the second recessed portion 672 of the plug member 67 and held by the plug member 67. The second spring 682 is set in a pressed and compressed state between the flange portion 662 of the third retainer member 66 and the plug member 67 (a bottom portion of the second recessed portion 672.) A layout configuration of the stopper member 65 and the like other than that is similar to the hydraulic chamber 50 of the master cylinder 5.

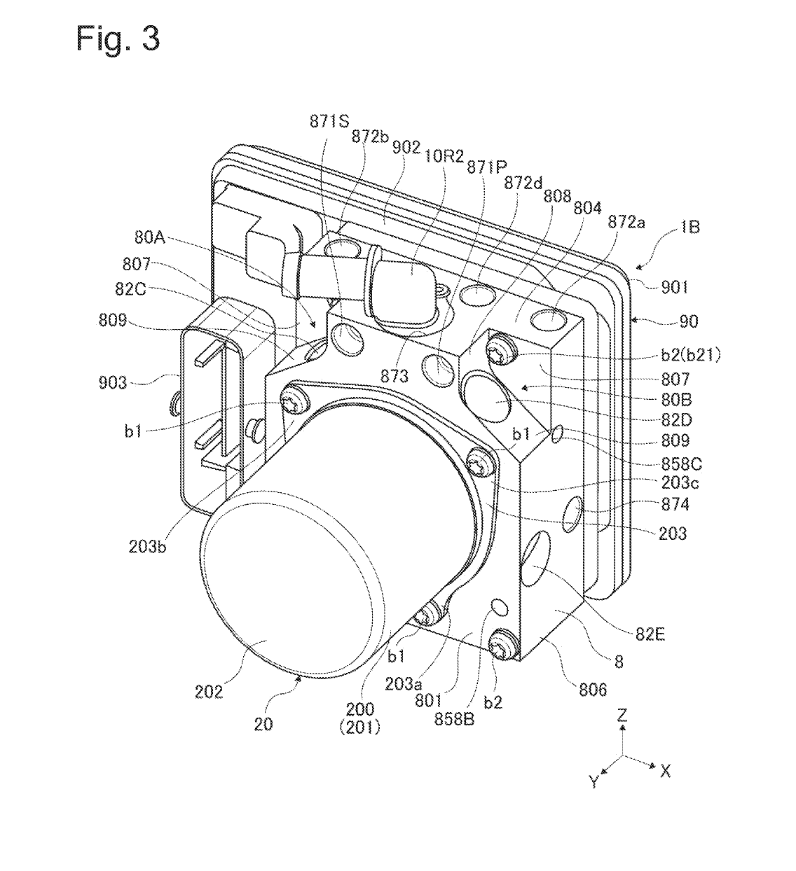

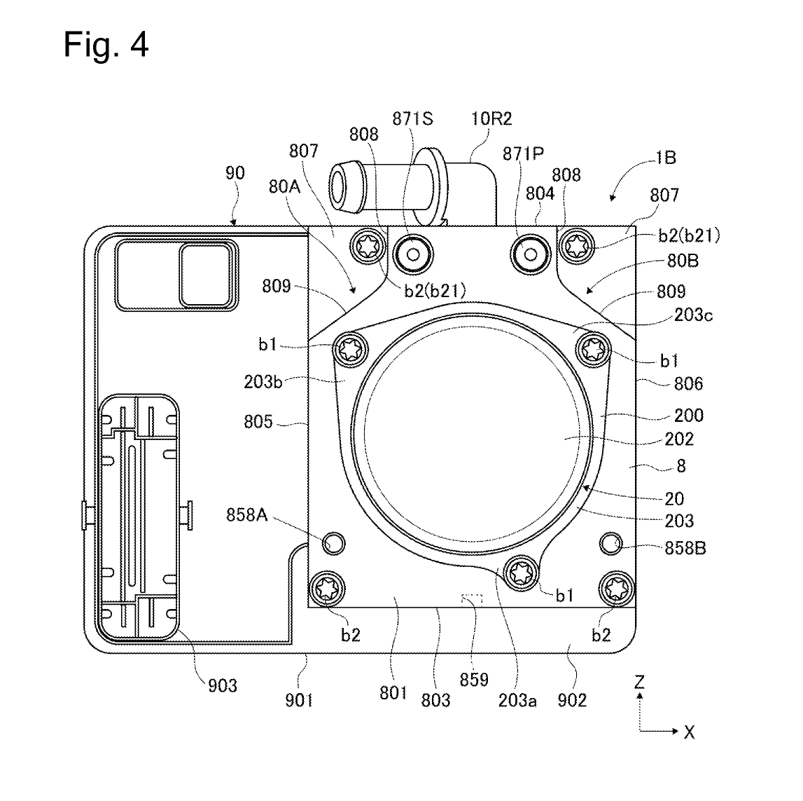

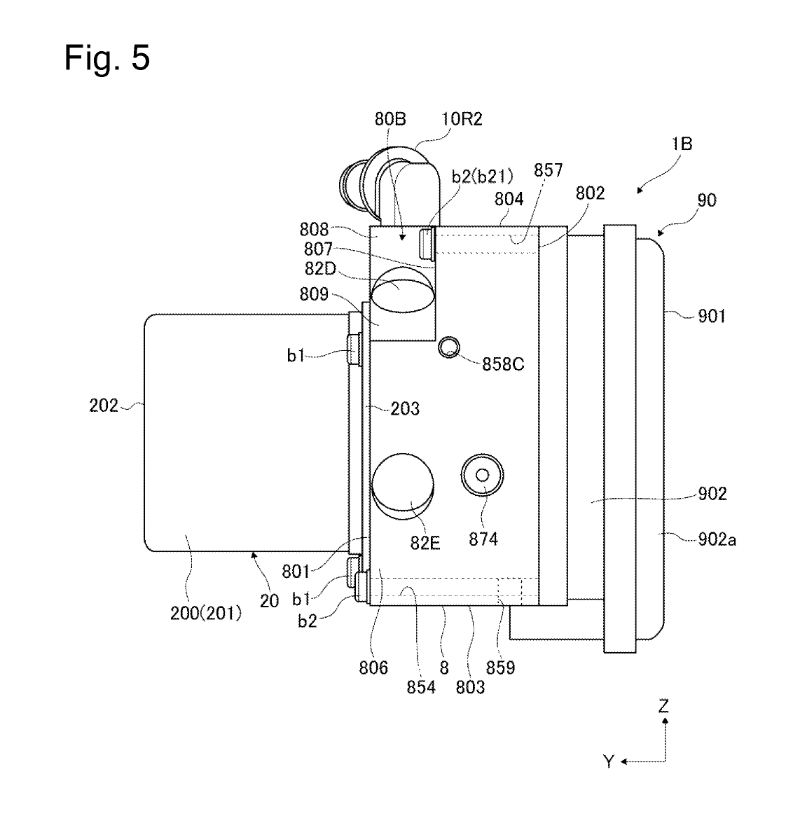

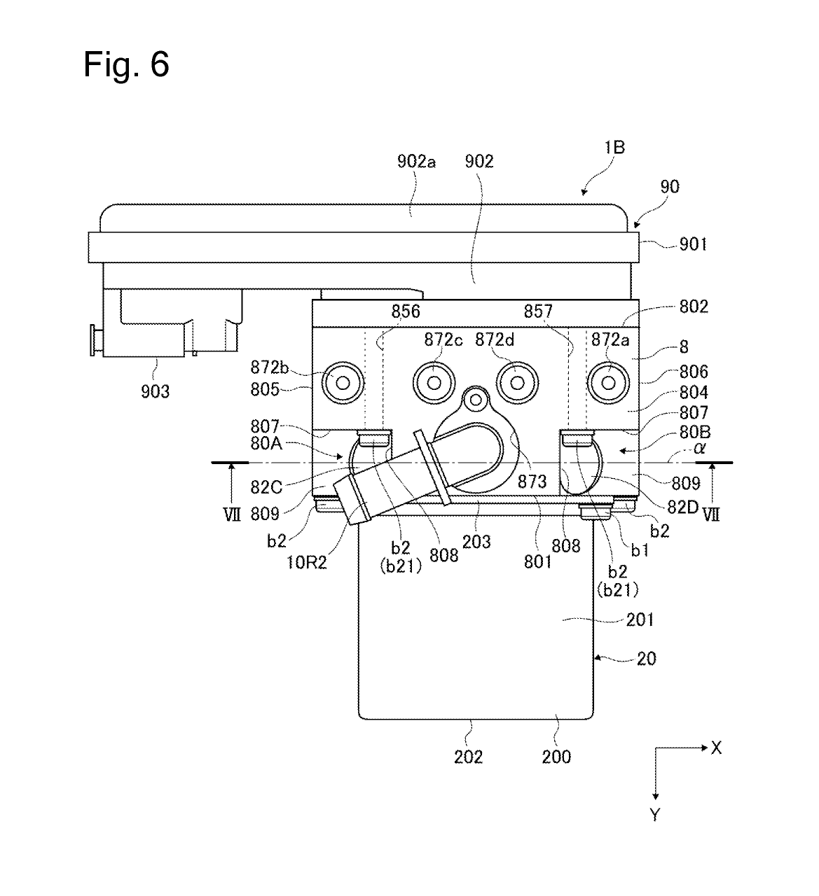

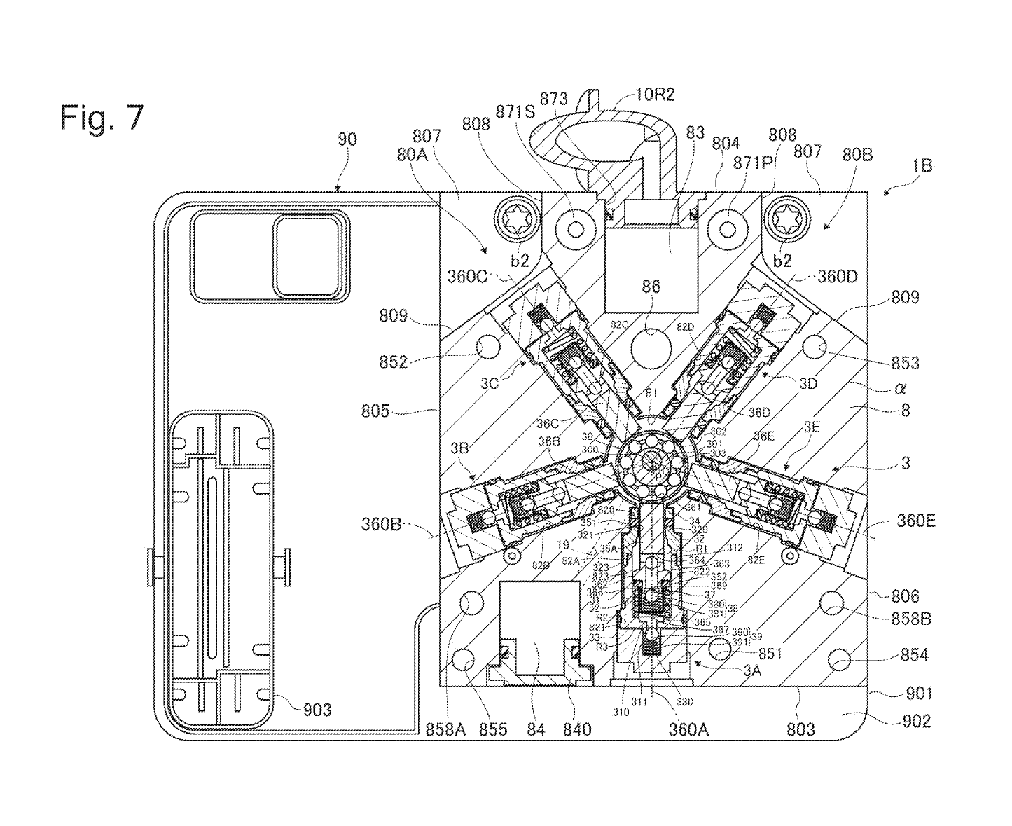

The second unit 1B is a hydraulic control apparatus provided between the first unit 1A and the brake actuation unit of each of the wheels FL to RR. FIGS. 3 to 6 illustrate an outer appearance of the second unit 1B. FIG. 3 is a perspective view of the second unit 1B as viewed from the X-axis positive direction side, the Y-axis positive direction side, and the Z-axis positive direction side. FIG. 4 is a front view of the second unit 1B as viewed from the Y-axis positive direction side. FIG. 5 is a right side view of the second unit 1B as viewed from the X-axis positive direction side. FIG. 6 is a top view of the second unit 1B as viewed from the Z-axis positive direction side. FIG. 7 illustrates a cross section taken along a line VII-VII in FIG. 6. The second unit 1B includes a housing 8, a motor 20, a pump 3, a plurality of electromagnetic valves 21 and the like, a plurality of hydraulic sensors 91 and the like, and an electronic control unit (a control unit, hereinafter referred to as an ECU) 90. The housing 8 contains (houses) the pump 3 and valve bodies of the electromagnetic valves 21 and the like therein. Circuits (brake hydraulic circuits) of the above-described two systems (the P system and the S system), through which the brake fluid flows, are formed by plurality of fluid passages inside the housing 8. The plurality of fluid passages includes supply fluid passages 11, an intake fluid passage 12, a discharge fluid passage 13, a pressure adjustment fluid passage 14, a pressure reduction fluid passage 15, a backpressure fluid passage 16, a first simulator fluid passage 17, and a second simulator fluid passage 18. Further, a plurality of ports 87 is formed inside the housing 8, and these ports 87 are opened on an outer surface of the housing 8. The plurality of ports 87 are connected to the fluid passages inside the housing 8, and connects these internal fluid passages and the fluid passages (the pipe 10M and the like) outside the housing 8 to each other. The plurality of ports 87 includes master cylinder ports 871 (a primary port 871P and a secondary port 871S), an intake port 873, a backpressure port 874, and wheel cylinder ports 872. The master cylinder ports 871 are connected to the supply fluid passages 11 inside the housing 8, and also connect the housing 8 (the second unit 1B) to the master cylinder 5 (the hydraulic chamber 50). An opposite end of the primary pipe 10MP is connected to the primary port 871P. An opposite end of the secondary pipe 10MS is connected to the secondary port 871S. The intake port 873 is connected to a first fluid pool chamber 83 inside the housing 8, and also connects the housing 8 to the reservoir tank 4 (the second chamber 43R). The nipple 10R2 is fixedly set in the intake port 873, and an opposite end of the intake pipe 10R is connected to the nipple 10R2. The backpressure port 874 is connected to the backpressure fluid passage 16 inside the housing, and also connects the housing 8 to the stroke simulator 6 (the backpressure chamber 602). An opposite end of the backpressure pipe 10X is connected to the backpressure port 874. The wheel cylinder ports 872 are connected to the supply fluid passages 11 inside the housing 8, and also connect the housing 8 (the second unit 1B) to the wheel cylinders W/C. One end of each of the wheel cylinder pipes 10W is connected to the wheel cylinder port 872.

The motor 20 is a rotary electric motor, and includes a rotational shaft for driving the pump 3. The motor 20 may be a brushed motor or may be a brushless motor including a resolver that detects a rotational angle or the number of rotations of the rotational shaft. The pump 3 is a second hydraulic source capable of supplying the hydraulic pressure to the wheel cylinder W/C, and includes five pump portions 3A to 3E configured to be driven by one motor 20. The pump 3 is used by the S system and the P system in common. The electromagnetic valves 21 and the like are each an actuator that operates according to a control signal, and each include a solenoid and a valve body. The valve body is stroked according to power supply to the solenoid to switch opening/closing of the fluid passage (establishes or blocks communication through the fluid passage). The electromagnetic valves 21 and the like each generate a control hydraulic pressure by controlling a communication state of the above-described circuit to adjust a flow state of the brake fluid. The plurality of electromagnetic valves 21 and the like include shut-off valves 21, pressure increase valves (hereinafter referred to as SOL/V INs) 22, communication valves 23, a pressure adjustment valve 24, pressure reduction valves (hereinafter referred to as SOL/V OUTs) 25, a stroke simulator IN valve (hereinafter referred to as an SS/V IN) 27, and a stroke simulator OUT valve (hereinafter referred to as an SS/V OUT) 28. The shut-off valves 21, the SOL/V INs 22, and the pressure adjustment valve 24 are each a normally opened valve opened when no power is supplied thereto. The communication valves 23, the pressure reduction valves 25, the SS/V IN 27, and the SS/V OUT 28 are each a normally closed valve closed when no power is supplied thereto. The shut-off valves 21, the SOL/V INs 22, and the pressure control valve 24 are each a proportional control valve, an opening degree of which is adjusted according to a current supplied to the solenoid. The communication valves 23, the pressure reduction valves 25, the SS/V IN 27, and the SS/V OUT 28 are each an ON/OFF valve, opening/closing of which is controlled to be switched between two values, i.e., switched to be either opened or closed. The proportional control valve can also be used as these valves. The hydraulic sensor 91 and the like detect a discharge pressure of the pump 3 and a master cylinder pressure. The plurality of hydraulic sensors includes a master cylinder pressure sensor 91, a discharge pressure sensor 93, and wheel cylinder pressure sensors 92 (a primary pressure sensor 92P and a secondary pressure sensor 92S).

In the following description, the brake hydraulic circuit of the second unit 1B will be described with reference to FIG. 2. Members corresponding to the individual wheels FL to RR will be distinguished from one another if necessary, by indices a to d added at the ends of reference numerals thereof, respectively. One end side of the supply fluid passage 11P is connected to the primary port 871P. An opposite end side of the fluid passage 11P branches off into a fluid passage 11a for the front left wheel and a fluid passage 11D for a rear right wheel 11d. Each of the fluid passages 11a and 11d are connected to the wheel cylinder port 872 corresponding thereto. One end side of the supply fluid passage 11S is connected to the secondary port 871S. An opposite end side of the fluid passage 11S branches off into a fluid passage 11b for the front right wheel and a fluid passage 11c for the rear left wheel. Each of the fluid passages 11b and 11c is connected to the wheel cylinder port 872 corresponding thereto. The shut-off valves 21 are provided on the above-described one end sides of the fluid passages 11. The SOL/V IN 22 is provided in each of the fluid passages 11a to 11d on the above-described opposite end side. A bypass fluid passage 110 is provided in parallel with each of the fluid passages 11 while bypassing the SOL/V IN 22, and a check valve 220 is provided in the fluid passage 110. The valve 220 permits only a flow of the brake fluid directed from one side where the wheel cylinder port 872 is located toward the other side where the master cylinder port 871 is located.

The intake fluid passage 12 connects the first fluid pool chamber 83 and an intake port 823 of the pump 3 to each other. One end side of the discharge fluid passage 13 is connected to a discharge port 821 of the pump 3. An opposite end side of the discharge fluid passage 13 branches off into a fluid passage 13P for the P system and a fluid passage 13S for the S system. Each of the fluid passages 13P and 13S are connected to portions of the supply fluid passages 11 between the shut-off valves 21 and the SOL/V INs 22. The communication valve 23 is provided in each of the fluid passages 13P and 13S. Each of the fluid passages 13P and 13S functions as a communication passage connecting the supply fluid passage 11P of the P system and the supply fluid passage 11S of the S system to each other. The pump 3 is connected to each of the wheel cylinder ports 872 via the above-described communication passages (the discharge fluid passages 13P and 13S) and the supply fluid passages 11P and 11S. The pressure reduction fluid passage 14 connects a portion of the discharge fluid passage 13 between the pump 3 and the communication valves 23, and the first fluid pool chamber 83 to each other. The pressure adjustment valve 24 as a first pressure reduction valve is provided in the fluid passage 14. The pressure reduction fluid passage 15 connects a portion of each of the fluid passages 11a to 11d of the supply fluid passages 11 between the SOL/V IN 22 and the wheel cylinder port 872, and the first fluid pool chamber 83 to each other. The SOL/V OUTs 25 as second pressure reduction valves are provided in the fluid passages 15.

One end side of the backpressure chamber 16 is connected to the backpressure port 874. An opposite end side of the fluid passage 16 branches off into the first simulator fluid passage 17 and the second simulator fluid passage 18. The first simulator fluid passage 17 is connected to a portion of the supply fluid passage 11S between the shut-off valve 21S and the SOL/V INs 22b and 22c. The SS/V IN 27 is provided in the fluid passage 17. A bypass fluid passage 170 is provided in parallel with the fluid passage 17 while bypassing the SS/V IN 27, and a check valve 270 is provided in the fluid passage 170. The valve 270 permits only a flow of the brake fluid directed from one side where the backpressure fluid passage 16 is located toward the other side where the supply fluid passage 11S is located. The second simulator fluid passage 18 is connected to the first fluid pool chamber 83. The SS/V OUT 28 is provided in the fluid passage 18. A bypass fluid passage 180 is provided in parallel with the fluid passage 18 while bypassing the SS/V OUT 28, and a check valve 280 is provided in the fluid passage 180. The valve 280 permits only a flow of the brake fluid directed from one side where the first fluid pool chamber 83 is located toward the other side where the backpressure fluid passage 16 is located. The hydraulic sensor 91 is provided between the shut-off valve 21S and the secondary port 871S in the supply fluid passage 11S. The hydraulic sensor 91 detects a hydraulic pressure at this portion (a hydraulic pressure in the positive pressure chamber 601 of the stroke simulator 6, and the master cylinder pressure). The hydraulic sensors 92 are provided between the shut-off valves 21 and the SOL/V INs 22 in the supply fluid passages 11. The hydraulic sensors 92 detects hydraulic pressures at these portions (corresponding to the wheel cylinder hydraulic pressures). The hydraulic sensor 93 is provided between the pump 3 and the communication valves 23 in the discharge fluid passage 13. The hydraulic sensor 93 detects a hydraulic pressure at this portion (the pump discharge pressure).

Each of the hydraulic chambers 50P and 50S of the master cylinder 5 is replenished with the brake fluid from the reservoir tank 4, and the hydraulic pressure (the master cylinder pressure) is generated by the movement of the piston 51. The master cylinder 5 is connected to the wheel cylinders W/C via the master cylinder pipes 10M, the supply fluid passages 11 (of the second unit 1B), and the wheel cylinder pipes 10W, and can increase the wheel cylinder hydraulic pressures. The brake fluid transmitted out of the master cylinder 5 according to the brake operation performed by the driver is delivered to the master cylinder pipes 10M, and is introduced into the supply fluid passages 11 of the second unit 1B via the master cylinder ports 871. The master cylinder 5 can increase the pressures in the wheel cylinders W/C (FL) and W/C (RR) with use of the master cylinder pressure generated in the primary chamber 50P via the fluid passage (the supply fluid passage 11P) of the P system. At the same time, the master cylinder 5 can increase the pressures in the wheel cylinders W/C (FR) and W/C (RL) with use of the master cylinder pressure generated due to the secondary chamber 50S via the fluid passage of the S system (the supply fluid passage 11S). The stroke sensor 94 detects the stroke of the primary piston 51P (the pedal stroke). The first unit 1A does not include a negative pressure booster that boosts the brake operation force input by the driver with use of a negative pressure generated by an engine of the vehicle or a separately provided negative pressure pump.

The brake fluid is delivered from the master cylinder 5 to the positive pressure chamber 601 of the stroke simulator 6 according to the brake operation performed by the driver, by which the pedal stroke is generated, and the reaction force (the pedal reaction force) of the brake operation performed by the driver is also generated due to the biasing force of the elastic member. When a hydraulic pressure (the master cylinder pressure) equal to or higher than a predetermined pressure is applied to a pressure-receiving surface of the piston 61 in the positive pressure chamber 601, the piston 61 is axially moved toward the backpressure chamber 602 side while pressing and compressing the spring 681 and the like. At this time, the volume of the positive pressure chamber 601 increases, and, at the same time, the volume of the backpressure chamber 602 reduces. As a result, the brake fluid transmitted out of the secondary chamber 50S is delivered into the positive pressure chamber 601 via the positive pressure fluid passage 74. At the same time, the brake fluid is transmitted out of the backpressure chamber 602, and the brake fluid in the backpressure chamber 602 is discharged. The backpressure chamber 602 is connected to the backpressure fluid passage 16 of the second unit 1B via the backpressure pipe 10X. The brake fluid transmitted out of the backpressure chamber 602 according to the brake operation performed by the driver is delivered into the backpressure pipe 10X, and is introduced into the backpressure fluid passage 16 via the backpressure port 874. The stroke simulator 6 introduces therein the brake fluid from the master cylinder 5 in this manner, thereby simulating hydraulic stiffness of the wheel cylinders W/C to thus imitate a feeling that the driver would have when pressing the pedal. When the pressure in the positive pressure chamber 601 reduces to lower than the predetermined pressure, the piston 61 is returned to an initial position due to the biasing force (an elastic force) of the spring 681 and the like. When the piston 61 is located at the initial position, a first gap in the X-axis direction is generated between the first damper 691 and the head portion 651 of the stopper member 65, and a second gap in the X-axis direction is generated between the second damper 692 and the bottom portion 661 of the third retainer member 66. When the first spring 681 is compressed by a distance equal to or longer than the first gap in the X-axis direction according to the stroke of the piston 61 toward the X-axis negative direction side, the first damper 691 starts to be elastically deformed by being sandwiched between the protruding portion 613 and the head portion 651. When the second spring 682 is compressed by a distance equal to or longer than the second gap in the X-axis direction, the second damper 692 starts to be elastically deformed by contacting the bottom portion 661. By these elastic deformations, an impact is reduced. Further, a characteristic about a relationship between the pedal pressing force (the pedal reaction force) and the pedal stroke can be adjusted. Therefore, the pedal feeling can be improved.

The second unit 1B supplies the brake fluid pressurized by the pump 3 to the brake actuation units via the wheel cylinder pipes 10W, thereby generating the brake hydraulic pressures (the wheel cylinder hydraulic pressures). The second unit 1B can supply the master cylinder pressure to each of the wheel cylinders W/C, and can also control the hydraulic pressure in each of the wheel cylinders W/C individually with use of the hydraulic pressure generated by the pump 3 independently of the brake operation performed by the driver with the communication blocked between the master cylinder 5 and the wheel cylinders W/C. The ECU 90 receives inputs of the values detected by the stroke sensor 94, the hydraulic sensor 91, and the like, and information regarding a running state from the vehicle side, and controls the opening/closing operations of the electromagnetic valves 21 and the like and the number of rotations of the motor 20 (i.e., the discharge amount of the pump 3) based on a program installed therein, thereby controlling the wheel cylinder hydraulic pressure (the hydraulic braking force) in each of the wheels FL to RR. By this control, the ECU 90 performs various kinds of brake control (anti-lock brake control for preventing or reducing a slip of the wheel due to the braking, boosting control for reducing a required driver's brake operation force, brake control for controlling a motion of the vehicle, automatic brake control such as adaptive cruise control, regenerative cooperative brake control, and the like). The control of the motion of the vehicle includes vehicle behavior stabilization control such as electronic stability control. In the regenerative cooperative brake control, the ECU 90 controls the wheel cylinder hydraulic pressures so as to achieve a target deceleration (a target braking force) in cooperation with regenerative brake.

The ECU 90 includes a brake operation amount detection portion 90a, a target wheel cylinder hydraulic pressure calculation portion 90b, a pressing force brake creation portion 90c, a boosting control portion 90d, and a control switching portion 90e. The brake operation amount detection portion 90a detects a displacement amount (the pedal stroke) of the brake pedal 100 as the brake operation amount upon receiving the input of the value detected by the stroke sensor 94. The target wheel cylinder hydraulic pressure calculation portion 90d calculates a target wheel cylinder hydraulic pressure. More specifically, the target wheel cylinder hydraulic pressure calculation portion 90b calculates the target wheel cylinder hydraulic pressure that realizes a predetermined boosting rate, i.e., an ideal characteristic about a relationship between the pedal stroke and a brake hydraulic pressure requested by the driver (a vehicle deceleration requested by the driver) based on the detected pedal stroke. Further, at the time of the regenerative cooperative brake control, the target wheel cylinder hydraulic pressure calculation portion 90b calculates the target wheel cylinder hydraulic pressure in relation to the regenerative braking force. For example, the target wheel cylinder hydraulic pressure calculation portion 90b calculates such a target wheel cylinder hydraulic pressure that a sum of the regenerative braking force input from a control unit of a regenerative braking apparatus of the vehicle and a hydraulic braking force corresponding to the target wheel cylinder hydraulic pressure can satisfy the vehicle deceleration requested by the driver. At the time of the motion control, the target wheel cylinder hydraulic pressure calculation portion 90b calculates the target wheel cylinder hydraulic pressure for each of the wheels FL to RR so as to, for example, realize a desired vehicle motion state based on a detected vehicle motion state amount (a lateral acceleration or the like).

The pressing force brake creation portion 90c deactivates the pump 3, and controls the shut-off valves 21, the SS/V IN 27, and the SS/V OUT 28 in opening directions, a closing direction, and a closing direction, respectively. The fluid passage system (the supply fluid passages 11 and the like) connecting the hydraulic chambers 50 of the master cylinder 5 and the wheel cylinders W/C to each other with the shut-off valves 21 controlled in the opening directions realizes the pressing force brake that creates the wheel cylinder hydraulic pressures by the master cylinder pressure generated with use of the pedal pressing force (non-boosting control). The SS/V OUT 28 is controlled in the closing direction, which prohibits the stroke simulator 6 from functioning. More specifically, the piston 61 of the stroke simulator 6 is prohibited from being activated, so that the brake fluid is prohibited from being introduced from the hydraulic chamber 50 (the secondary chamber 50S) into the positive pressure chamber 601. This allows the wheel cylinder hydraulic pressure to be further efficiently increased. The SS/V IN 27 may be controlled in an opening direction.

when the SS/V IN 27 and the SS/V OUT 28 are controlled in the closing direction and the opening direction, respectively, with the shut-off valves 21 controlled in the closing directions, the brake system connecting the first fluid pool chamber 83 and the wheel cylinders W/C to each other (the intake oil passage 12, the discharge oil passage 13, and the like) creates the wheel cylinder hydraulic pressures by the hydraulic pressure generated with use of the pump 3, and functions as a so-called brake-by-wire system that realizes the boosting control, the regenerative cooperative control, and the like. The boosting control portion 90d activates the pump 3 and controls the shut-off valves 21 and the communication valves 23 in the closing directions and opening directions, respectively, thereby making the state of the second unit 1B ready to create the wheel cylinder hydraulic pressures with use of the pump 3, at the time of the brake operation performed by the driver. By this operation, the boosting control portion 90d creates higher wheel cylinder hydraulic pressures than the master cylinder pressure as a hydraulic source of the discharge pressure of the pump 3 to perform the boosting control that generates a hydraulic braking force by which the driver's braking operation force falls short. More specifically, the boosting control portion 90d realizes the target wheel cylinder hydraulic pressure by controlling the pressure adjustment valve 24 while keeping the pump 3 activated at a predetermined number of rotations to adjust the brake fluid amount to be supplied from the pump 3 to the wheel cylinders W/C. In other words, the brake system 1 exerts a boosting function that assists the brake operation force by activating the pump 3 of the second unit 1B instead of the engine negative pressure booster. Further, the boosting control portion 90d controls the SS/V IN 27 and the SS/V OUT 28 in the closing direction and the opening direction, respectively. By this operation, the boosting control portion 90d causes the stroke simulator 6 to function.

Further, the ECU 90 includes a sudden brake operation state determination portion 90f and a second pressing force brake creation portion 90g. The sudden brake operation state determination portion 90f detects a brake operation state based on an input from the brake operation amount detection portion 90a and the like, and determines (detects) whether the brake operation state is a predetermined sudden brake operation state. For example, the sudden brake operation state determination portion 90f determines whether an amount of a change in the pedal stroke per unit time exceeds a predetermined threshold value. When the brake operation is determined to be the sudden brake operation state, the control switching portion 90e switches control so as to create the wheel cylinder hydraulic pressures by the second pressing force brake creation portion 90. The second pressing force brake creation portion 90g activates the pump 3 and controls the shut-off valves 21, the SS/V IN 27, and the SS/V OUT 28 in the closing directions, the opening direction, and the closing direction. By this operation, the second pressing force brake creation portion 90g realizes the second pressing force brake that creates the wheel cylinder hydraulic pressures with use of the brake fluid transmitted out of the backpressure chamber 602 of the stroke simulator 6 until the pump 3 is ready to generate sufficiently high wheel cylinder pressures. The second pressing force brake creation portion 90g may control the shut-off valves 21 in the opening directions. Further, the second pressing force brake creation portion 90g may control the SS/V IN 27 in the closing direction, and, in this case, the brake fluid from the backpressure chamber 602 is supplied to the wheel cylinder W/C side via the check valve 270 (brought into a opened state because the pressure in the wheel cylinder W/C side is still lower than the backpressure chamber 602 side). In the present embodiment, the brake fluid can be efficiently supplied from the backpressure chamber 602 side to the wheel cylinder W/C side by controlling the SS/V IN 27 in the opening direction. After that, when the brake operation state starts to be determined not to be the sudden brake operation state and/or a predetermined condition indicating that a discharge capacity of the pump 3 becomes sufficient is satisfied, the control switching portion 90e switches the control so as to create the wheel cylinder hydraulic pressures by the boosting control portion 90d. In other words, the control switching portion 90e controls the SS/V IN 27 and the SSV OUT 28 in the closing direction and the opening direction, respectively. By this operation, the control switching portion 90e causes the stroke simulator 6 to function. The control switching portion 90e may operate so as to switch the control to the regenerative cooperative brake control after the second pressing force brake.

The SS/V OUT 28, the SS/V IN 27, and the check valve 270 adjust a flow of the brake fluid introduced from the backpressure port 874 into the housing 8 via the backpressure pipe 10X. These valves permit or prohibit the inflow of the brake fluid from the master cylinder 5 into the stroke simulator 6 (the positive pressure chamber 601) by permitting or prohibiting the brake fluid introduced from the backpressure port 874 into the housing 8 to be delivered or from being delivered toward one of the low-pressure portions (the first fluid pool chamber 83 and the wheel cylinders W/C). By this operation, these valves adjust the activation of the stroke simulator 6. Further, the SS/V OUT 28, the SS/V IN 27, and the check valve 270 function as a switching portion that switches a supply destination (an outflow destination) of the brake fluid introduced from the backpressure port 874 into the housing 8 (the backpressure fluid passage 16) between the first fluid pool chamber 83 and the wheel cylinders W/C. The control switching portion 90e controls the SS/V OUT 28 in the closing direction so as to realize the second pressing force brake until the pump 3 is ready to generate the sufficiently high wheel cylinder pressures. By this operation, the brake fluid introduced from the backpressure chamber 602 of the stroke simulator 6 into the backpressure fluid passage 16 is delivered toward the supply fluid passages 11 via the SS/V IN 27 (the first simulator fluid passage 17) and the check valve 270 (the bypass fluid passage 170). In other words, the supply destination of the brake fluid transmitted out of the backpressure chamber 602 is switched to the wheel cylinders W/C. Therefore, responsiveness for increasing the wheel cylinder hydraulic pressures can be ensured. When the pressure on the wheel cylinder W/C side exceeds the pressure on the backpressure chamber 602 side, the check valve 270 is automatically brought into a closed state, which prevents or reduces a reverse flow of the brake fluid from the wheel cylinder W/C side to the backpressure chamber 602 side. When the brake operation state is determined to be the sudden brake operation state, the control switching portion 90e controls the SS/V OUT 28 in the closing direction to switch the supply destination of the brake fluid to the wheel cylinders W/C. Therefore, the control switching portion 90e can correctly realize the second pressing force brake in a situation requiring the responsiveness for increasing the wheel cylinder hydraulic pressures. The pump 3 is a reciprocating pump, and therefore has relatively high responsiveness. Therefore, it takes a relatively short time for the pump 3 to become ready to generate the sufficient wheel cylinder pressures since the pump 3 starts the activation, which allows the second pressing force brake to be activated in a shorter time period. When the predetermined condition indicating that the discharge capacity of the pump 3 becomes sufficient is satisfied, the control switching portion 90e controls the SS/V OUT 28 in the opening direction so as to cause the stroke simulator 6 to function. By this operation, the brake fluid introduced from the backpressure chamber 602 into the backpressure fluid passage 16 is delivered toward the first fluid pool chamber 83 via the SS/V OUT 28 (the second simulator fluid passage 18). In other words, the supply destination of the brake fluid transmitted out of the backpressure chamber 602 is switched to the first fluid pool chamber 83. Therefore, an excellent pedal feeling can be ensured. Even in the case of occurrence of such a failure that the SS/V OUT 28 is stuck in the closed state during the activation of the stroke simulator 6, the piston 61 can return to the initial position due to the supply of the brake fluid from the first fluid pool chamber 83 side to the backpressure chamber 602 via the check valve 280.

In the following description, the housing 8 of the second unit 1B will be described. The housing 8 is a generally cuboidal block formed with use of aluminum alloy as a material thereof. The outer surface of the housing 8 includes a front surface 801, a back surface 802, a bottom surface 803, a top surface 804, a left side surface 805, and a right side surface 806. The front surface 801 (a first surface) is a flat surface relatively large in area. The back surface 802 (a second surface) is a flat surface generally in parallel with the front surface 801 and faces the front surface 801 (opposite of the housing 8 from the front surface 801). The bottom surface 803 (a third surface) is a flat surface connected to the front surface 801 and the back surface 802. The top surface 804 (a fourth surface) is a flat surface generally in parallel with the bottom surface 803 and faces the bottom surface 803 (opposite of the housing 8 from the bottom surface 803). The left side surface 805 (a fifth surface) is a flat surface connected to the front surface 801, the back surface 802, the bottom surface 803, and the top surface 804. The right side surface 806 (a sixth surface) is a flat surface generally parallel with the left side surface 805 and faces the left side surface 805 (opposite of the housing 8 from the left side surface 805). The right side surface 806 is connected to the front surface 801, the back surface 802, the bottom surface 803, and the top surface 804. The front surface 801 is disposed on the Y-axis positive direction side and extends in parallel with the X axis and the Z axis with the housing 8 mounted on the vehicle. The back surface 802 is disposed on the Y-axis negative direction side and extends in parallel with the X axis and the Z axis. The top surface 804 is disposed on the Z-axis positive direction side and extends in parallel with the X axis and the Y axis. The bottom surface 803 is disposed on the Z-axis negative direction side and extends in parallel with the X axis and the Y axis. The right side surface 806 is disposed on the X-axis positive direction side and extends in parallel with the Y axis and the Z axis. The left side surface 805 is disposed on the X-axis negative direction side and extends in parallel with the Y axis and the Z axis. In actual use, the layout of the housing 8 in an XY plane is not limited in any manner, and the housing 8 can be arranged in the XY plane at any position and in any orientation according to the vehicle layout and/or the like.

A recessed portion 80 is formed at each of corner portions of the housing 8 on one side where the front surface 801 is located and another side where the top surface 804 is located. In other words, a vertex formed by the front surface 801, the top surface 804, and the right side surface 806, and a vertex formed by the front surface 801, the top surface 804, and the left side surface 805 have truncated shapes, and include first and second recessed portions 80A and 80B, respectively. The first recessed portion 80A is exposed (opened) on the front surface 801, the top surface 804, and the left side surface 805. The second recessed portion 80B is exposed (opened) on the front surface 801, the top surface 804, and the right side surface 806. The first recessed portion 80A includes a first flat surface portion 807, a second flat surface portion 808, and a third flat surface portion 809. The first flat surface portion 807 extends orthogonally to the Y axis and in parallel with an XZ plane. The second flat surface portion 808 extends orthogonally to the X axis and generally in parallel with a YZ plane. The third flat surface 809 extends in the Y-axis direction and forms an angle of approximately 50 degrees with respect to the right side surface 806 in a counterclockwise direction as viewed from the Y-axis positive direction side. The second flat surface portion 808 and the third flat surface portion 809 are connected to each other smoothly via a concaved curved surface extending in the Y-axis direction. The second recessed portion 80B includes a first flat surface portion 807, a second flat surface portion 808, and a third flat surface portion 809. The third flat surface portion 809 extends in the Y-axis direction and forms an angle of approximately 50 degrees with respect to the left side surface 806 in a clockwise direction as viewed from the Y-axis positive direction side. A configuration of the second recessed portion 80B other than that is similar to the first recessed portion 80A. The first and second recessed portions 80A and 80B are generally symmetric with respect to the YZ plane at a center of the housing 8 in the X-axis direction.

The housing 8 includes a cam containing hole 81, a plurality of (five) cylinder containing holes 82A to 82E, the first fluid pool chamber 83, a second fluid pool chamber 84, a plurality of fixation holes 85, a plurality of valve containing holes, a plurality of sensor containing holes, a power source hole 86, the plurality of ports 87, the plurality of fluid passages 11, and the like. These holes and ports are formed with use of a drill or the like. The cam containing hole 81 has a bottomed cylindrical shape extending in the Y-axis direction, and is opened on the front surface 801. A central axis O of the cam containing hole 81 is disposed at a position of the front surface 801 that is generally central in the X-axis direction and slightly offset from a center in the Z-axis direction toward the Z-axis negative direction side. The bottom surface 803 is positioned on the Z-axis negative direction side with respect to the central axis O, and the first recessed portion 80A and the second recessed portion 80B are positioned on the Z-axis positive direction side with respect to the central axis O.

Each of the cylinder containing holes 82 has a stepped cylindrical shape and has a central axis extending in a radial direction of the cam containing hole 81 (a radial direction around the central axis O). The hole 82 includes a small-diameter portion 820 on one side closer to the cam containing hole 81, a large-diameter portion 821 on the other side farer away from the cam containing hole 81, and an intermediate-diameter portion 822 between the small-diameter portion 820 and the large-diameter portion 821. A part 823 of the intermediate-diameter portion 822 on the one side closer to the cam containing hole 81 functions as an intake port, and the large-diameter portion 821 functions as a discharge port. The plurality of holes 82A to 82E is disposed generally evenly (at generally even intervals) in a direction extending around the central axis O. An angle formed by the central axes of the holes 82 adjacent to each other in the direction extending around the central axis O is approximately 72 degrees (falls within a predetermined range including 72 degrees). The plurality of holes 82A to 82E is arrayed in one row along the Y-axis direction, and is disposed on a Y-axis positive direction side of the housing 8. In other words, the central axes of these holes 82A to 82E are located in a same plane α generally orthogonal to the central axis O. The plane α extends generally in parallel with the front surface 801 and the back surface 802 of the housing 8, and is located closer to the front surface 801 than to the back surface 802. The intake port 823 of each of the holes 82A to 82E is connected to one another via a first communication fluid passage. The discharge port 821 of each of the holes 82A to 82E is connected to one another via a second communication fluid passage.

Each of the holes 82A to 82E is disposed inside the housing 8 in the following manner. The hole 82A extends from the bottom surface 803 to the Z-axis positive direction side. The hole 82B extends from a portion of the left side surface 805 that is positioned on a lower side in the Z-axis negative direction with respect to the central axis O to the X-axis positive direction side and the Z-axis positive direction side. The hole 82C extends from the first recessed portion 80A to the X-axis positive direction side and the Z-axis negative direction side. The hole 82D extends from the second recessed portion 80B to the X-axis negative direction side and the Z-axis negative direction side. The hole 82E extends from a portion of the right side surface 806 that is positioned on the lower side in the Z-axis negative direction with respect to the central axis O to the X-axis negative direction side and the Z-axis positive direction side. On the Z-axis negative direction side with respect to the central axis O, the hole 82A is positioned at the same position in the X-axis direction as the central axis O, and the holes 82B and 82E are disposed on opposite sides of the central axis O (the hole 82A) from each other in the X-axis direction. On the Z-axis positive direction side with respect to the central axis O, the holes 82C and 82D are disposed on opposite sides of the central axis O from each other in the X-axis direction. The small-diameter portion 820 of each of the holes 82A to 82E is opened on an inner peripheral surface of the cam containing hole 81. An end of the hole 82A on the large-diameter portion 821 side is opened at a portion of the bottom surface 803 that is generally central in the X-axis direction and located on the Y-axis positive direction side. An end of the hole 82B on the large-diameter portion 821 side is opened on a portion of the left side surface 805 that is located on the Y-axis positive direction side and the Z-axis negative direction side. An end of the hole 82E on the large-diameter portion 821 side is opened on a portion of the right side surface 806 that is located on the Y-axis positive direction side and the Z-axis negative direction side. Ends of the holes 82C and 82D on large-diameter portion 821 sides are opened on the first and second recessed portions 80A and 80B, respectively. More specifically, more than half of the end on the large-diameter portion 821 side is opened on the third flat surface portion 809, and a remaining portion thereof is opened on the second flat surface portion 808. The third flat surface portion 809 extends generally orthogonally to the central axes of the holes 82C and 82D.

The first fluid pool chamber 83 has a bottomed cylindrical shape having a central axis extending in the Z-axis direction. The first fluid pool chamber 83 is opened on a portion of the top surface 804 that is generally central in the X-axis direction and offset toward the Y-axis positive direction, and is disposed from the top surface 804 into the housing 8. The first fluid pool chamber 83 (a bottom portion thereof on the Z-axis negative direction side) is disposed on a Z-axis positive direction side of each of the cylinder containing holes 82 with respect to the intake port 823. The first fluid pool chamber 83 is formed in a region between the cylinder containing holes 82C and 82D adjacent to each other in the direction extending around the central axis O on the Z-axis positive direction side with respect to the central axis O. The first fluid pool chamber 83 and the holes 82C and 82D partially overlap each other in the Y-axis direction (as viewed from the X-axis direction). The first fluid pool chamber 83 and the intake port 823 of each of the holes 82A to 82E are connected to each other via the intake fluid passage 12. The second fluid pool chamber 84 has a bottomed cylindrical shape having a central axis extending in the Z-axis direction. The second fluid pool chamber 84 is opened on a portion of the bottom surface 803 that is located on the X-axis negative direction side and offset toward the Y-axis positive direction, and is disposed from the bottom surface 803 into the housing 8. The second fluid pool chamber 84 is formed in a region between the cylinder containing holes 82A and 82B adjacent to each other in the direction extending around the central axis O on the Z-axis negative direction side with respect to the central axis O. The cylinder containing hole 82A and the second fluid pool chamber 84 partially overlap each other in the Y-axis direction (as viewed from the X-axis direction). The cam containing hole 81 and the second fluid pool chamber 84 are connected to each other via the drain fluid passage 19. One end of the drain fluid passage 19 is opened on a portion on an inner peripheral surface of the cam containing hole 81 that is located on the Y-axis negative direction side and the Z-axis negative direction side, and an opposite end of the drain fluid passage 19 is opened on an outer peripheral edge of the bottom surface of the second fluid pool chamber 84 on the Z-axis positive direction side.

The plurality of valve containing holes each has a bottomed cylindrical shape, and extends in the Y-axis direction to be opened on the back surface 802. The plurality of valve containing holes is arrayed in one row along the Y-axis direction, and is disposed on a Y-axis negative direction side of the housing 8. The cylinder containing holes 82 and the valve containing holes are arranged along the Y-axis direction. The plurality of valve containing holes at least partially overlaps the cylinder containing holes 82 as viewed from the Y-axis direction. Most of the plurality of valve containing holes is contained in a circle connecting ends of the plurality of cylinder containing holes 82 on the large-diameter portion 821 sides (the other sides farer away from the central axis O). Alternatively, an outer periphery of this circle and the valve containing holes at least partially overlap each other. A valve portion of the electromagnetic valve is fitted and a valve portion thereof is contained in each of the valve containing holes. The bypass fluid passage 120 and the check valve 220 are each formed by a cup-like seal member or the like set in the valve containing hole. The plurality of sensor containing holes each has a bottomed cylindrical shape having a central axis extending in the Y-axis direction, and is opened on the back surface 802. A pressure-sensitive portion such as the hydraulic sensor 91 is contained in each of the sensor containing portions. The power source hole 86 has a cylindrical shape and penetrates through the housing 8 (between the front surface 801 and the back surface 802) in the Y-axis direction. The hole 86 is disposed at a portion of the housing 8 that is located at a generally central position in the X-axis direction and on the Z-axis positive direction side. The hole 86 is disposed (formed) in a region between the cylinder containing holes 82C and 82D adjacent to each other.

The intake port 873 is an opening portion of the first fluid pool chamber 83 on the top surface 804, and is opened on an upper side in the vertical direction. The port 873 is opened at a portion of the top surface 804 that is located on the central side in the X-axis direction and offset toward the Y-axis positive direction (a position closer to the front surface 801 than the wheel cylinder ports 872 are). The port 873 is disposed on the Z-axis positive direction side with respect to the intake port 823 of each of the cylinder containing holes 82A to 82E. The cylinder containing holes 82C and 82D sandwich the port 873 as viewed from the Y-axis direction. The opening of each of the cylinder containing holes 82C and 82D and the port 873 partially overlap each other in the Y-axis direction (as viewed from the X-axis direction). The master cylinder ports 871 each have a bottomed cylindrical shape having a central axis extending in the Y-axis direction, and are opened on portions that are an end of the front surface 801 on the Z-axis positive direction side and is sandwiched between the recessed portions 80A and 80B. The primary port 871P is disposed on the X-axis positive direction side, and the secondary port 871S is disposed on the X-axis negative direction side. Both the ports 871P and 871S are arranged in the X-axis direction, and sandwich the first fluid pool chamber 83 in the X-axis direction (as viewed from the Y-axis direction). The ports 871P and 871S are sandwiched between the first fluid pool chamber 83 and the cylinder containing holes 82C and 82D in the direction extending around the central axis O (as viewed from the Y-axis direction), respectively. The wheel cylinder ports 872 each have a bottomed cylindrical shape having a central axis extending in the Z-axis direction, and is opened on a Y-axis negative direction side of the top surface 804 (a position closer to the back surface 802 than to the front surface 801). The ports 872a to 872d are arranged in one row in the X-axis direction. The two ports 872a and 872d of the P system are disposed on the X-axis positive direction side, and the two ports 872b and 872c of the S system are disposed on the X-axis negative direction side. The port 872a is disposed on the X-axis positive direction side with respect to the port 872d in the P system, and the port 872b is disposed on the X-axis negative direction side with respect to the port 872c in the S system. The ports 872c and 872d sandwich the intake port 873 (the first fluid pool chamber 83) as viewed from the Y-axis direction. The ports 872 and the first fluid pool chamber 83 partially overlap each other in the Z-axis direction. Openings of the ports 872 and the intake port 873 (an opening of the first fluid pool chamber 83) partially overlap each other in the X-axis direction (as viewed from the Y-axis direction). The intake port 873 (the first fluid pool chamber 83) is located inside a quadrilateral defined by connecting the ports 871P, 871S, 872c, and 872d (centers thereof) with line segments, as viewed from the Z-axis direction. The first fluid pool chamber 83 is disposed in a region surrounded by the master cylinder ports 871 and the wheel cylinder ports 872. The backpressure port 874 has a bottomed cylindrical shape having a central axis extending in the X-axis direction, and is opened on a portion of the right side surface 806 that is located on the Y-axis negative direction side and offset from the central axis O toward the Z-axis negative direction side. The plurality of fluid passages 11 and the like connect the ports 87, the fluid pool chambers 83 and 84, the cylinder containing holes 82, the valve containing holes, and the hydraulic sensor containing holes to one another.

The plurality of fixation holes 85 include bolt holes 851 to 853 for fixing the motor (refer to FIG. 7), bolt holes 854 to 857 for fixing the ECU (refer to FIGS. 5 to 7), and a bolt hole 858 and a pin hole 859 for fixing the housing (refer to FIGS. 4 and 5). The bolt holes 851 to 853 each have a bottomed cylindrical shape having a central axis extending in the Y-axis direction, and are opened on the front surface 801. The holes 851 to 853 are located on the Y-axis positive direction side of the housing 8, and partially overlap the cylinder containing hole 82 in the Y-axis direction. The holes 851 to 853 are provided at positions generally symmetric with respect to the central axis O of the cam containing hole 81. Distances from the central axis O to the individual holes 851 to 853 are generally equal to one another. The holes 852 and 853 are located on opposite sides of the central axis O from each other in the X-axis direction and on the Z-axis positive direction side with respect to the central axis O. The holes 852 and 853 are located adjacent to the cylinder containing holes 82C and 82D (the large-diameter portions 821 thereof) on one sides closer to the side surfaces 805 and 805 with respect to the cylinder containing holes 82C and 82D (on opposite sides of the cylinder containing holes 82 from the first fluid pool chamber 83), respectively, and are also located adjacent to the third flat surface portions 809 of the recessed portions 80A and 80B, respectively. The hole 851 is located on the X-axis positive direction side with respect to the cylinder containing hole 82A and on the Z-axis negative direction side with respect to the central axis O. The hole 851 is located adjacent to the cylinder containing hole 82A (the large-diameter portion 821 thereof), and is also located adjacent to the bottom surface 803 on an opposite side of the cylinder containing hole 82A from the second fluid pool chamber 84. The bolt holes 854 to 857 each have a cylindrical shape having a central axis extending in the Y-axis direction, and penetrate through the housing 8. The holes 854 and 855 are located on one side closer to the bottom surface 803, and the holes 856 and 857 are located on the other side closer to the top surface 804. The holes 854 and 855 are positioned at corner portions sandwiched between the bottom surface 803 and the side surfaces 805 and 806, and are opened on the front surface 801 and the backs surface 802. The holes 856 and 857 are positioned at corner portions sandwiched between the top surface 804 and the second flat surface portions 808 of the recessed portions 80 as viewed from the Y-axis direction, and are opened on the first flat surfaces 807 of the recessed portions 80 and the back surface 802. The hole 856 is located adjacent to the wheel cylinder port 872b and is sandwiched between the ports 872b and 872c in the X-axis direction. The hole 857 is located adjacent to the wheel cylinder port 872a and is sandwiched between the ports 872a and 872d in the X-axis direction. The bolt holes 858A and 858B are positioned on the Z-axis negative direction side with respect to the central axis O. The holes 858A and 858B each have a bottomed cylindrical shape having a central axis extending in the Y-axis direction, and are opened on both ends of the front surface 801 in the X-axis direction. The holes 858A and 858B are located on the Y-axis positive direction side of the housing 8, and partially overlap the cylinder containing holes 82 in the Y-axis direction. The holes 858A and 858B are located adjacent to the side surfaces 805 and 806, and are sandwiched between the cylinder containing holes 82B and 82E and the bolt holes 855 and 854 in the Z-axis direction, respectively. The hole 858A on the X-axis negative direction side is sandwiched between the left side surface 805 and the second fluid pool chamber 84. The hole 858A is positioned on an opposite side of a vicinity of the central axis O from the primary port 871P. The hole 858B on the X-axis positive direction side is positioned on an opposite side of the vicinity of the central axis O from the secondary port 871S. The hole 858C is positioned on the Z-axis positive direction side with respect to the central axis O. The hole 858C has a bottomed cylindrical shape having a central axis extending in the X-axis direction, and is opened at a generally central portion of the right side surface 806 in the Y-axis direction. The hole 858C is opened while being located adjacent to a corner portion sandwiched between the first flat surface portion 807 and the third flat surface portion 809 of the second recessed portion 80B as viewed from the X-axis direction. The hole 858C is positioned on an opposite side of the vicinity of the central axis O from the hole 858A. The pin hole 859 has a bottomed cylindrical shape having a central axis extending in the Z-axis direction, and is opened on a portion of the bottom surface 803 that is located at a generally central position in the X-axis direction and on the Y-axis negative direction side. The pin hole 859 is located adjacent to a Y-axis negative direction side of the cylinder containing hole 82A. The pin hole 859 overlaps the cylinder containing hole 82A as viewed from the Y-axis direction.

(Fixation of Motor)

The motor 20 is disposed and a motor housing 200 is attached on the front surface 801 of the housing 8. The front surface 801 functions as a motor attachment surface. The bolt holes 851 to 853 function as a fixation portion for fixing the motor 20 to the housing 8. The motor 20 includes the motor housing 200. The motor housing 200 has a bottomed cylindrical shape, and includes a cylindrical portion 201, a bottom portion 202, and a flange portion 203. The cylindrical portion 201 contains a magnet as a stator, a rotor, and the like on an inner peripheral side, if being assumed to be a brushed DC motor by way of example. A rotational shaft of the motor 20 extends on a central axis of the cylindrical portion 201. The bottom portion 202 closes one axial side of the cylindrical portion 201. The flange portion 203 is provided at an end of the cylindrical portion 201 on an opposite axial side (an opening side), and flares radially outwardly from an outer peripheral surface of the cylindrical portion 201. The flange portion 203 includes first, second, and third protruding portions 203a, 203b, and 203c. A bolt hole penetrates through each of the protruding portions 203a to 203c. A bolt b1 is inserted in each of the bolt holes, and the bolt b1 is fastened in each of the bolt holes 851 to 853 of the housing 8. The flange portion 203 is fastened onto the front surface 801 by the bolts b1. A conductive member (a power source connector) for power supply is connected to the rotor via a brush. The conductive member (the power source connector) is contained (attached) in the power source hole 86, and protrudes from the back surface 802 toward the Y-axis negative direction side. The master cylinder ports 871 are positioned on the Z-axis positive direction side with respect to the central axis O and on the Z-axis positive direction side with respect to the motor 20 (the motor housing 200).

(Pump)

FIG. 7 illustrates a cross section of the second unit 1B taken along the plane α. The central axis (an axial line) of the rotational shaft of the motor 20 generally coincides with the central axis O of the cam containing hole 81. A rotational driving shaft 300, which is a rotational shaft and a driving shaft of the pump 3, and a cam unit 30 are contained in the cam containing hole 81 (inside the housing 8). The rotational driving shaft 300 is the driving shaft of the pump 3. The rotational driving shaft 300 is fixedly coupled with the rotational shaft of the motor 20 in such a manner that a central axis thereof extends on an extension of the central axis of the rotational shaft of the motor 20, and is rotationally driven by the motor 20. The central axis of the rotational driving shaft 300 generally coincides with the central axis O. The rotational driving shaft 300 rotates around the central axis O integrally with the rotational shaft of the motor 20. The cam unit 30 is provided on the rotational driving shaft 300. The cam unit 30 includes a cam 301, a driving member 302, and a plurality of rolling members 303. The cam 301 is a columnar eccentric cam, and has a central axis P eccentric with respect to the central axis O of the rotational driving shaft 300. The central axis P extends generally in parallel with the central axis O. The cam 301 swings while rotating around the central axis O integrally with the rotational driving shaft 300. The driving member 302 has a cylindrical shape, and is disposed on an outer peripheral side of the cam 301. A central axis of the driving member 302 generally coincides with the central axis P. The driving member 302 is rotatable around the central axis P relative to the cam 301. The driving member 302 has a similar configuration to an outer race of a rolling bearing. The plurality of rolling members 303 is disposed between an outer peripheral surface of the cam 301 and an inner peripheral surface of the driving member 302. The rolling members 303 are needle rollers, and extend along a direction of the central axis of the rotational driving shaft 300.

The pump 3 is a radial plunger pump in the form of a fixed cylinder, and includes the housing 8, the rotational driving shaft 300, the cam unit 30, and the plurality of (five) pump portions 3A to 3E. The pump portions 3A to 3E are each a plunger pump (a piston pump) as a reciprocating pump, and are activated by the rotation of the rotational driving shaft 300. The brake fluid as the hydraulic fluid is introduced and discharged according to a reciprocating movement of plungers (pistons) 36. The cam unit 30 has a function of converting the rotational movement of the rotational driving shaft 300 into the reciprocating movement of the plungers 36. When a configuration of each of the pump portions 3A to 3E is distinguished from each other, indices A to E are added to the reference numerals thereof. The individual plungers 36 are disposed around the cam unit 30, and are each contained in the cylinder containing hole 82. A central axis 360 of the plunger 36 generally coincides with the central axis of the cylinder containing hole 82, and extends in a radial direction of the rotational driving shaft 300. In other words, the plungers 36 as many as the number of the cylinder containing holes 82 (five) are provided, and extend radially with respect to the central axis O. The plungers 36A to 36E are disposed generally evenly in a direction extending around the rotational driving shaft 300 (hereinafter simply referred to as a circumferential direction), i.e., at generally even intervals in a direction in which the rotational driving shaft 300 rotates. Central axes 360A to 360E of these plungers 36A to 36E are located on the same plane α. These plungers 36A to 36E are driven by the same rotational driving shaft 300 and the same cam unit 30.

The pump portion 3A includes a cylinder sleeve 31, a filter member 32, a plug member 33, a guide ring 34, a first seal ring 351, a second seal ring 352, the plunger 36, a return spring 37, an intake valve 38, and a discharge valve 39, and these components are set in the cylinder containing hole 82. The cylinder sleeve 31 has a bottomed cylindrical shape, and a hole 311 penetrates through a bottom portion 310 thereof. The cylinder sleeve 31 is fixed in the cylinder containing hole 82. A central axis of the cylinder sleeve 31 generally coincides with the central axis 360 of the cylinder containing hole 82. An end 312 of the cylinder sleeve 31 on an opening side is disposed on the intermediate-diameter portion 822 (the intake port 823), and the bottom portion 310 is disposed on the large-diameter portion (discharge port) 821. The filter member 32 has a bottomed cylindrical shape, and a hole 321 penetrates through a bottom portion 320 thereof and a plurality of opening portions also penetrates through a side wall portion thereof. A filter is set on each of these opening portions. An end 323 of the filter member 32 on an opening side is fixed to the end 312 of the cylinder sleeve 31 on the opening side. The bottom portion 320 is disposed on the small-diameter portion 820. A central axis of the filter member 32 generally coincides with the central axis 360 of the cylinder containing hole 82. A gap is generated between an outer peripheral surface where the opening portion of the filter member 32 is opened and an inner peripheral surface of the cylinder containing hole 82 (the intake port 823). The first communication fluid passage is in communication with the intake port 823 and the above-described gap. The plug member 33 has a columnar shape, and includes a recessed portion 330 and a groove on one axial side thereof. This groove extends radially to connect the recessed portion 330 and an outer peripheral surface of the plug member 33 to each other, and is in communication with the discharge port 821. The above-described one axial side of the plug member 33 is fixed to the bottom portion 310 of the cylinder sleeve 31. A central axis of the plug member 33 generally coincides with the central axis 360 of the cylinder containing hole 82. The plug member 33 is fixed to the large-diameter portion 821, and closes an opening of the cylinder containing hole 82 on the outer peripheral surface of the housing 8. The second communication fluid passage is in communication with the discharge port 821 and the above-described groove of the plug member 33. The guide ring 34 has a cylindrical shape, and is fixed on the one side of the cylinder containing hole 82 that is located closer to the cam containing hole 81 (the small-diameter portion 82) with respect to the filter member 32. A central axis of the guide ring 34 generally coincides with the central axis 360 of the cylinder containing hole 82. The first seal ring 351 is set between the guide ring 34 and the filter member 32 in the cylinder containing hole 82 (the small-diameter portion 820).

The plunger 36 has a columnar shape, and includes an end surface (hereinafter referred to as a plunger end surface) 361 on one axial side thereof and a flange portion 362 on an outer periphery on an opposite axial side thereof. The plunger end surface 361 has a flat surface-like shape extending in a direction generally orthogonal to the central axis 360 of the plunger 36, and has a generally circular shape centered at the central axis 360. The plunger 36 includes an axial hole 363 and a radial hole 364 therein. The axial hole 363 extends on the central axis 360 to be opened on an end surface of the plunger 36 on the above-described opposite axial side. The radial hole 364 extends in a radial direction of the plunger 36 to be opened on an outer peripheral surface on the above-described one axial side with respect to the flange portion 362 and to be also connected to the above-described one axial side of the axial hole 363. A check valve case 365 is fixed at an end of the plunger 36 on the above-described opposite axial side. The check valve case 365 has a bottomed cylindrical shape made from a thin plate, and includes a flange portion 366 on an outer periphery of an end thereof on an opening side and a plurality of holes 368 penetrating through a side wall portion and a bottom portion 367 thereof. The end of the check valve case 365 on the opening side is fitted to the end of the plunger 36 on the above-described opposite axial side. The second seal ring 352 is set between the flange portion 366 of the check valve case 365 and the flange portion 362 of the plunger 36. The above-described opposite axial side of the plunger 36 is inserted in an inner peripheral side of the cylinder sleeve 31, and the plunger portion 362 is guided and supported by the cylinder sleeve 31. The above-described one axial side of the plunger 36 with respect to the radial hole 364 is inserted in an inner peripheral side (the hole 321) of the bottom portion 320 of the filter member 32, an inner peripheral side of the first seal ring 351, and an inner peripheral side of the guide ring 34, and is guided and supported by them. The central axis 360 of the plunger 36 generally coincides with the central axis of the cylinder sleeve 31 and the like (the cylinder containing hole 82). The end of the plunger 36 on the above-describe one axial side (the plunger end surface 361) protrudes to inside the cam containing hole 81.

The return spring 37 is a compression coil spring, and is set on the inner peripheral side of the cylinder sleeve 31. One end and an opposite end of the return spring 37 are set on the bottom portion 310 of the cylinder sleeve 31 and the flange portion 366 of the check valve case 365, respectively. The return spring 37 constantly biases the plunger 36 toward the one side where the cam containing hole 81 is located relative to the cylinder sleeve 31 (the cylinder containing hole 82). The intake valve 38 includes a ball 380 as a valve body and a return spring 381, and these are contained on an inner peripheral side of the check valve case 365. A valve seat 369 is provided around the opening of the axial hole 363 on the end surface of the plunger 36 on the above-described opposite axial side. The ball 380 is seated on the valve seat 369, by which the axial hole 363 is closed. The return spring 381 is a compression coil spring, and one end and an opposite end thereof are set on the bottom portion 367 of the check valve case 365 and the ball 380, respectively. The return spring 381 constantly biases the ball 380 toward one side where the valve seat 369 is located relative to the check valve case 365 (the plunger 36). The discharge valve 39 includes a ball 390 as a valve body and a return spring 391, and these are contained in the recessed portion 330 of the plug member 33. A valve seat 313 is provided around an opening portion of the through-hole 311 at the bottom portion 310 of the cylinder sleeve 31. The ball 390 is seated on the valve seat 313, by which the through-hole 311 is closed. The return spring 391 is a compression coil spring, and one end and an opposite end thereof are set on a bottom surface of the recessed portion 330 and the ball 390, respectively. The return spring 391 constantly biases the ball 390 toward one side where the valve seat 313 is located.

Inside the cylinder containing hole 82, a space R1 on one side closer to the cam containing hole 82 with respect to the flange portion 362 of the plunger 36 is a space on the intake side in communication with the first communication fluid passage. More specifically, a space extending from the above-described gap between the outer peripheral surface of the filter member 32 and the inner peripheral surface (the intake port 823) of the cylinder containing hole 82, passing through the plurality of openings of the filter member 32, and a gap between an outer peripheral surface of the plunger 36 and an inner peripheral surface of the filter member 32, and leading to the radial hole 364 and the axial hole 363 of the plunger 36 functions as the intake-side space R1. This intake-side space R1 is prevented from communicating with the cam containing hole 81 by the first seal ring 351. Inside the cylinder containing hole 82, a space R3 between the cylinder sleeve 31 and the plug member 33 is a discharge-side space in communication with the second communication fluid passage. More specifically, a space extending from the above-described groove of the plug member 33 to the discharge port 821 functions as the discharge-side space R3. On the inner peripheral side of the cylinder sleeve 31, a volume of a space R2 between the flange portion 362 of the plunger 36 and the bottom portion 310 of the cylinder sleeve 31 changes due to reciprocation (a stroke) of the plunger 36 relative to the cylinder sleeve 31. This space R2 is in communication with the intake-side space R1 due to opening of the intake valve 38, and is in communication with the discharge-side space R3 due to opening of the discharge valve 39. The plunger 36 of the pump portion 3A exerts a pump function by reciprocating. More specifically, when the plunger 36 is stroked toward the cam containing hole 81 (the central axis O), the volume of the space R2 increases and a pressure in R2 reduces. Due to closing of the discharge valve 39 and the opening of the intake valve 38, the brake fluid as the hydraulic fluid is introduced from the intake-side space R1 to the space R2, and the brake fluid is supplied from the first communication fluid passage into the space R2 via the intake port 823. When the plunger 36 is stroked away from the cam containing hole 81, the volume of the space R2 reduces and the pressure in R2 increases. Due to closing of the intake valve 38 and the opening of the discharge valve 39, the brake fluid is transmitted out of the space R2 into the discharge-side space R3, and the brake fluid is supplied into the second communication fluid passage via the discharge port 821. The other pump portions 3B to 3E also have similar configurations. The brake fluid discharged to the second communication fluid passage by each of the pump portions 3A to 3E is collected into the single discharge fluid passage 13, and is used in common by the two hydraulic circuit systems.

(Fixation of ECU)

The ECU 90 is disposed and attached on the back surface 802 of the housing 8. In other words, the ECU 90 is provided integrally with the housing 8. The ECU 90 includes a control board and a control unit housing (case) 901. The control board controls states of power supply to the motor 20 and the solenoids of the electromagnetic valves 21 and the like. Various kinds of sensors that detect the motion state of the vehicle, such as an acceleration sensor that detects an acceleration of the vehicle, and an angular speed sensor that detects an angular speed (a yaw rate) of the vehicle, may be mounted on the control board. Further, a combination sensor (a combined sensor) formed by unitizing these sensors may be mounted on the control board. The control board is contained in the case 901. The case 901 is a cover member attached to the back surface 802 (the bolt holes 854 to 857) of the housing 8 with use of bolts b2. The back surface 802 functions as a case attachment surface (a cover member attachment surface). The bolt holes 854 to 857 function as a fixation portion for fixing the ECU 90 to the housing 8. Head portions of the bolts b2 are disposed on one side where the front surface 801 of the housing 8 is located. Shaft portions of the bolts b2 penetrate through the bolt holes 854 to 857, and distal end sides of the shaft portions are threadably engaged with female screws on the other side where the case 901 is located. The case 901 is fastened and fixed to the back surface 802 of the housing 8 with the aid of axial forces of the bolts b2. The head portions b21 of the bolts b2 protrude in the first recessed portion 80A and the second recessed portion 80B, respectively. The head portions b21 are contained inside the recessed portions 80 and do not protrude beyond the front surface 801 toward the Y-axis positive direction side.

The case 901 is a cover member made from a resin material, and includes a board containing portion 902 and a connector portion 903. The board containing portion 902 contains therein the control board and parts of the solenoids of the electromagnetic valves 21 and the like (hereinafter referred to as the control board and the like). The board containing portion 902 includes a cover portion 902a. The cover portion 902a covers the control board and the like and isolates them from outside. The control board is mounted on the board containing portion 902 generally in parallel with the back surface 802. Terminals of the solenoids of the electromagnetic valves 21 and the like, terminals of the hydraulic sensor 91 and the like, and the conductive member from the motor 20 protrude from the back surface 802. The above-described terminals and conductive member extend toward the Y-axis negative direction side to be connected to the control board. The connector portion 903 is disposed on an X-axis negative direction side of the board containing portion 902 with respect to the above-described terminals and conductive member, and protrudes toward a Y-axis positive direction side of the board containing portion 902. The connector portion 903 is disposed on a slightly outer side (the X-axis negative direction side) with respect to the left side surface 805 of the housing 8 as viewed from the Y-axis direction. A terminal of the connector portion 903 is exposed toward the Y-axis positive direction side, and also extends toward the Y-axis negative direction side to be connected to the control board. Each terminal of the connector portion 903 (which is exposed toward the Y-axis positive direction side) is connectable to an external apparatus or the stroke sensor (hereinafter referred to as the external apparatus and the like). An electric connection is established between the external apparatus and the like and the control board (the ECU 90) by insertion of another connector connected to the external apparatus and the like into the connector portion 903 from the Y-axis positive direction side. Further, power is supplied from an external power source (a battery) to the control board via the connector portion 903. The conductive member functions as a connection portion that electrically connects the control board and the motor 20 (the rotor thereof) to each other, and power is supplied from the control board to the motor 20 (the rotor thereof) via the conductive member.

(Fixation of Housing)

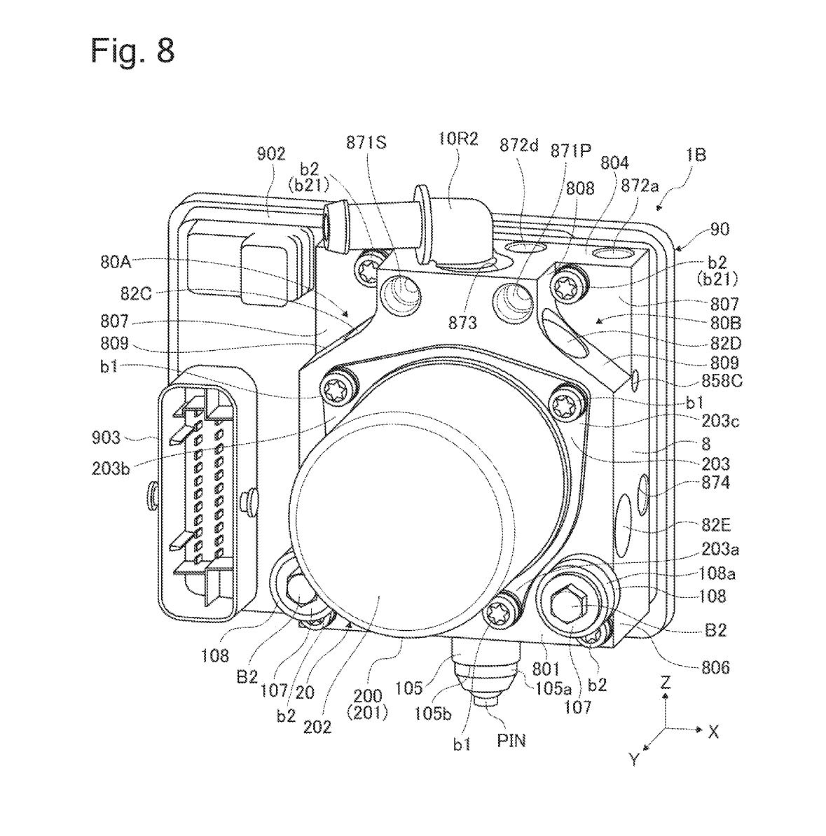

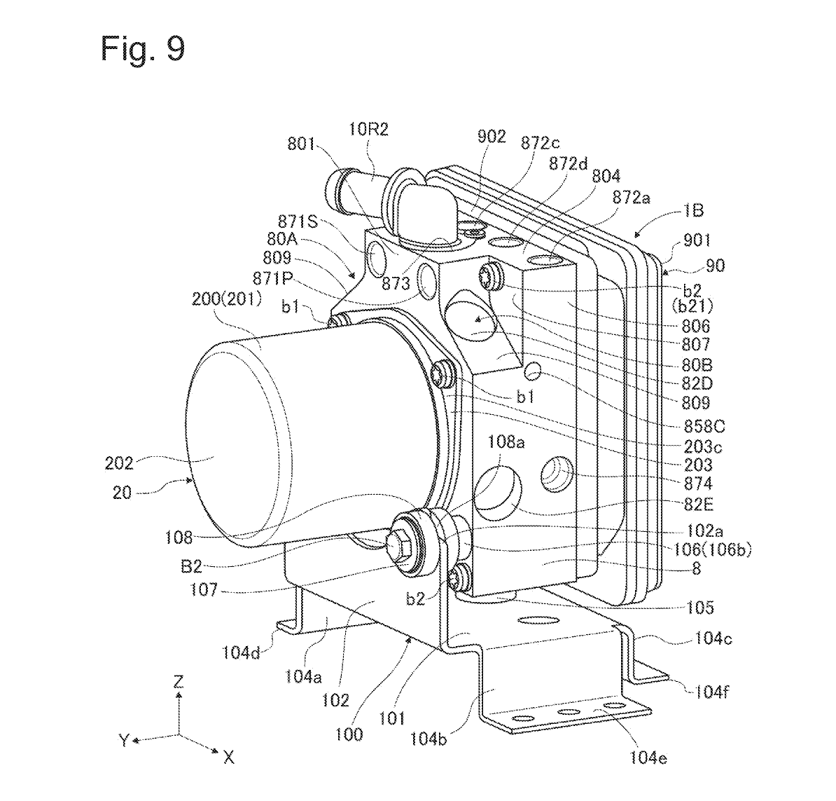

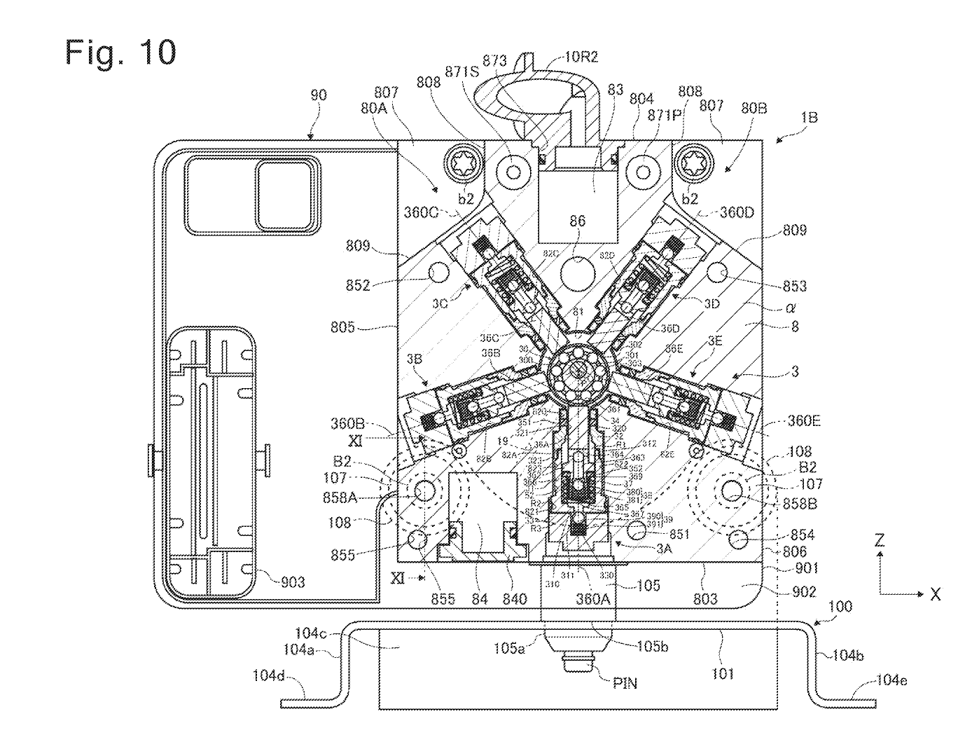

FIG. 8 is a perspective view illustrating the second unit 1B with the pin PIN, bolts B2, insulators 105 and 108, and the like attached thereto as viewed from the X-axis positive direction side, the Y-axis positive direction side, and the Z-axis positive direction side. FIG. 9 is a perspective view illustrating the second unit 1B in a state mounted on a mount 100 as viewed from the X-axis positive direction side, the Y-axis positive direction side, and the Z-axis positive direction side. FIG. 10 is a front view illustrating the second unit 1B in the state mounted on the mount 100 as viewed from the Y-axis positive direction side. The housing 8 and like are illustrated in cross-section taken along the plane α, and a second mount portion 102, the bolts B2, and the like are indicated by broken lines.

The mount 100 is a base formed by bending and folding a metallic plate, and is fastened and fixed to the vehicle boy side (normally, a mounting member provided on a bottom surface or a side wall in the engine room and formed so as to be fitted to the mount 100) with use of bolts. The mount 100 may be fixed to the vehicle body side by welding. The mount 100 integrally includes a first mount portion 101, the second mount portion 102, and leg portions 104. The first mount portion 101 is disposed generally in parallel with the X axis and the Y axis. An insulator hole is formed on a portion of the first mount portion 101 that is generally central in the X-axis direction and located on the Y-axis negative direction side. The second mount portion 102 extends from an end of the first mount portion 101 in the Y-axis positive direction toward the Z-axis positive direction side. An end edge of the second mount portion 102 in the Z-axis positive direction is curved in a concaved manner so as to conform to a shape of the cylindrical portion 201 of the motor housing 200. Ends of the second mount portion 102 on the both sides in the X-axis direction include recessed portions 102a on ends in the Z-axis positive direction, respectively. The recessed portion 102a on the X-axis positive direction side is opened on the Z-axis positive direction side and the X-axis positive direction side. The recessed portion 102b on the X-axis negative direction side is opened on the Z-axis positive direction side and the X-axis negative direction side. The leg portions 104 include leg portions 104a to 104f. The leg portion 102a extends from an end of the first mount portion 101 in the X-axis negative direction to the Z-axis negative direction side. The leg portion 102b extends from an end of the first mount portion 101 in the X-axis positive direction to the Z-axis negative direction side. The leg portion 104c extends from an end of the first mount portion 101 in the Y-axis negative direction to the Z-axis negative direction side. The leg portion 102d extends from an end of the leg portion 102a in the Z-axis negative direction to the X-axis negative direction side. A plurality of bolt holes is formed on the leg portion 102d so as to be arranged in the Y-axis direction. The bolts for fixing the mount 100 to the vehicle body side are inserted into these holes from the Z-axis positive direction side. The leg portion 102e extends from an end of the leg portion 102b in the Z-axis negative direction to the X-axis positive direction side. A plurality of bolt holes is formed on the leg portion 102e so as to be arranged in the Y-axis direction. The bolts for fixing the mount 100 to the vehicle body side are inserted into these holes from the Z-axis positive direction side. The leg portion 102f extends from an end of the leg portion 102c in the Z-axis negative direction to the Y-axis negative direction side. A plurality of bolt holes is formed on the leg portion 102f so as to be arranged in the X-axis direction. The bolts for fixing the mount 100 to the vehicle body side are inserted into these holes from the Z-axis positive direction side.

The pin PIN is press-fitted and fixed in the pin hole 859 of the housing 8. The pin PIN is inserted in the insulator hole of the first mount portion 101. The pin PIN fixes the bottom surface 803 of the housing 8 to the first mount portion 101 via the insulator 105. The bolts B2 are inserted and fixed in the bolt holes 858A and 858B of the housing 8. The bolts B2 are inserted in the recessed portion 102a of the second mount portion 102. The bolts B2 fix the front surface 801 of the housing 8 to the second mount portion 102 via the insulators 108. The pin PIN and the bolts B2 are made from metal. The holes 858 and 859 function as a fixation portion for fixing the housing 8 to the vehicle body side (the mount 100). The insulators 105 and 108 are each an elastic member for preventing or reducing (insulating) a vibration, and are made from a rubber material.

The insulator 105 of the first mount portion 101 has a cylindrical shape, and includes a small-diameter portion 105a and an annular stepped portion 105b extending in a direction around a central axis thereof on one axial side of an outer peripheral surface. An inner diameter of the insulator 105 is generally equal to an outer diameter of the pin PIN (a shaft portion thereof). The insulator 105 is fitted to an outer periphery of the pin PIN (the shaft portion thereof). The small-diameter portion 105a is fitted in the insulator hole of the first mount portion 101. The stepped portion 105b is in contact with an outer peripheral edge of the insulator hole from the Z-axis positive direction side. An axial end surface of the insulator 105 is in contact with the bottom surface 803 of the housing 8 from the Z-axis negative direction side. An elastic deformation of the insulator 105 allows a slight displacement of the pin PIN relative to the first mount portion 101. The pin PIN is a structure supporting the housing 8 (the bottom surface 803) and functions as a support portion of the bottom surface 803.

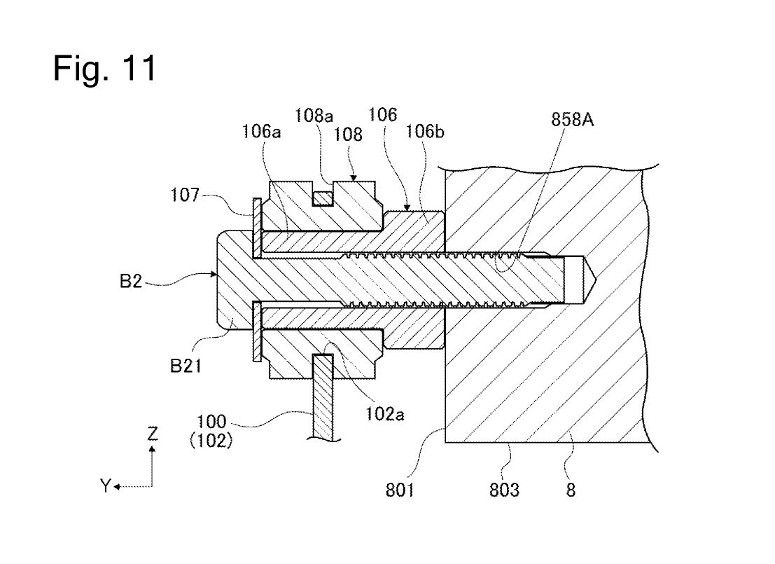

FIG. 11 illustrates a cross section of the bolt B2 and the like attached in the bolt hole 858A taken along a plane passing through a central axis of the bolt B2. FIG. 11 corresponds to a cross section as viewed from a line XI-XI illustrated in FIG. 10. The bolt B2 is fixed to the housing 8 via a collar member 106 and a washer 107. The collar member 106 is formed into a cylindrical shape from a metallic material, and includes a small-diameter portion 106a and a large-diameter portion 106b. An outer diameter of the large-diameter portion 106b is larger than an outer diameter of the small-diameter portion 106a, and the outer diameter of the small-diameter portion 106a is generally equal to an outer diameter of a head portion B21 of the bolt B2. The washer 107 is formed into an annular plate-like shape from a metallic material, and an outer diameter thereof is larger than the outer diameter of the head portion B21. The insulators 108 of the second mount portion 102 each have a cylindrical shape, and include an annular groove 108a extending in a direction around a central axis at a generally central portion on an outer peripheral surface in the axial direction. An axial dimension of the insulator 108 is generally equal to an axial dimension of the small-diameter portion 106b. An inner diameter of the insulator 108 is generally equal to the outer diameter of the small-diameter portion 106a. The bolt B2, the collar member 106, and the washer 107 (they will be hereinafter referred to as the bolt B2 and the like) are fixed to the housing 8. A male screw on an distal end side of the above-described shaft portion is threadably engaged with a female screw of the bolt hole 858A with the shaft portion of the bolt B2 penetrating through the collar member 106 and the washer 107. An axial end surface of the large-diameter portion 106b is in contact with the front surface 801 of the housing 8, an axial end surface of the small-diameter portion 106a is in contact with a surface of the washer 107 on one side, and a surface of the washer 107 on an opposite side is in contact with the head portion B21 of the bolt B2. The insulator 108 is fitted to an outer periphery of the small-diameter portion 106a. The recessed portion 102a of the second mount portion 102 is fitted to the groove 108a of the insulator 108. An elastic deformation of the insulator 108 allows a slight displacement of the bolt B2 and the like relative to the second mount portion 102. The bolt B2 and the like are a structure supporting the housing 8 (the front surface 801), and function as a support portion of the front surface 801. A support portion of the second mount portion 102 on the X-axis positive direction side is also configured in a similar manner.

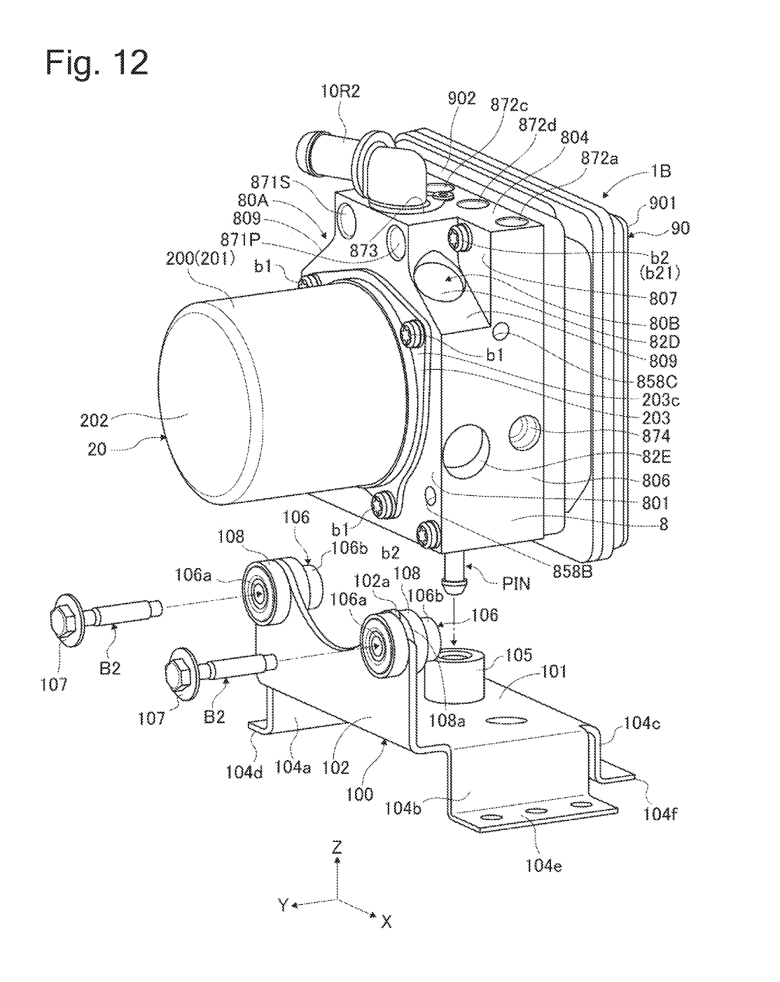

FIG. 12 is an exploded perspective view illustrating processes of mounting the second unit 1B onto the mount 100. In a first process, the insulator 105 is attached to the first mount portion 101, and the insulators 108 and the collar members 106 are attached to the second mount portion 102. The pin PIN is press-fitted in the bottom surface 803. In a second process, the housing 8 is moved relative to the mount toward the Z-axis negative direction side, and the pin PIN is inserted in the inner periphery of the insulator 105 as indicated by an arrow in FIG. 12. The bottom surface 803 is in contact with end surfaces of the insulators 108 in the Z-axis positive direction. In a third process, the shaft portions of the bolts B2 are inserted in inner peripheries of the collar members 106 as indicated by arrows in FIG. 12, and the distal end sides of the above-described shaft portions are inserted in the bolt holes 858A and 858B, with the washers 107 attached to the bolts B2. The shaft portions are threadably engaged with the bolt holes 858A and 858B due to rotations of the head portions B21 of the bolts B2. The collar members 106 are sandwiched between the head portions B21 (the washers 107) and the front surface 801 and are fixed to the front surface 801 with the aid of the axial forces of the bolts B2.

Next, functions will be described.

### (Reduction in Pulse Pressure of Pump)

The pump 3 may be any pump including a member reciprocatable according to a motion of the cam, and a specific configuration thereof is not limited to the example according to the present embodiment. In the present embodiment, the pump 3 includes the plurality of pump portions 3A to 3E. A straight line defined by extending the central axis 360 of the arbitrary pump portion 3A or the like beyond the central axis O of the rotational driving shaft 300 has an angle larger than 0 degree in the direction around the central axis O relative to the central axis 360 of the other pump portion 3C, 3D, or the like. In other words, the central axes 360 of the two pump portions 3A and 3C or the like opposite of the central axis O from each other are not located on the same straight line, and form the angle larger than 0 degree. Therefore, respective intake/discharge strokes of the pump portions 3A to 3E are not synchronized and out of phase with one another. This allows periodic changes (pulse pressures) of respective discharge pressures of the pump portions 3A to 3E to reduce each other, thereby succeeding in reducing a pulse pressure as the entire pump 3. In other words, a change as large as a sum of the discharge pressures of the plurality of pump portions 3A to 3E can be reduced as the entire pump 3. The present embodiment can reduce noise and a vibration of the brake system 1 by reducing pulsation of the flow in the discharge fluid passage 13 into which each of the pump portions 3A to 3E discharges the brake fluid in common.

The plurality of plungers 36 is disposed at the generally even intervals in the circumferential direction. In other words, each of the plungers 36 is arrayed generally evenly in the circumferential direction. Therefore, the present embodiment can reduce the change as large as the sum of the discharge pressures of the plurality of pump portions 3A to 3E as much as possible as the entire pump 3 by allowing the pump portions 3A to 3E to have generally even phase shifts of the intake/discharge strokes among them. Therefore, the present embodiment can acquire a further high effect of reducing the pulse pressure. The number of pump portions 3A to 3E may be an even number. In the present embodiment, the above-described number is an odd number equal to or larger than three. Therefore, compared to when the above-described number is an even number, the present embodiment can easily reduce the magnitude of the pulse pressure (a width of the change) as the entire pump 3 by shifting the phases while disposing the plurality of pump portions 3A to 3E at the generally even intervals in the circumferential direction, thereby noticeably acquiring the effect of reducing the pulse pressure. For example, in the case where the above-described number is three, a higher effect of reducing the pulse pressure can be acquired than when the above-described number is six. The number of pump portions 3A to 3E (the plungers 36) is not limited to five, and may be, for example, three. In the present embodiment, the above-described number is five. Therefore, compared to when the above-described number is three, the present embodiment can improve the effect of reducing the pulse pressure to thus acquire sufficient quietness, and can also ensure a sufficient discharge amount as the entire pump 3 while preventing or cutting down an increase in the size of the second unit 1B by reducing the size of each of the pump portions 3A to 3E. Further, compared to when the above-described number is six or more, the present embodiment cuts down the increase in the number of pump portions 3A to 3E, and therefore is advantageous in terms of a layout and the like and can easily achieve a reduction in the size of the second unit 1B.

The number of pump portions 3C and 3D positioned on the vertically upper side with respect to the central axis O is two, and the number of pump portions 3A, 3B, and 3E positioned on the vertically lower side with respect to the central axis O is three. The number of pump portions on the vertically lower side is larger than on the vertically upper side, which makes it easy to position a center of gravity of the second unit 1B on the vertically lower side. Positioning the center of gravity of the second unit 1B on the vertically lower side can improve installation stability of the second unit 1B. At least single pump portion 3A among the pump portions 3A, 3B, and 3E positioned on the vertically lower side is disposed from the bottom surface 803 into the housing 8. Therefore, the present embodiment facilitates disposing the pump portions 3A, 3B, and 3E at the generally even intervals in the direction around the central axis O on the vertically lower side compared to when the pump portion is not disposed from the bottom surface 803. The pump portions 3A, 3B, and 3E positioned on the vertically lower side are disposed from the bottom surface 803, the left side surface 805, and the right side surface 806 into the housing 8, respectively. Respectively assigning the openings of the pump portions 3A, 3B, and 3E to these surfaces in this manner further facilitates disposing the pump portions 3A, 3B, and 3E at the generally even intervals in the direction around the central axis O on the vertically lower side. The pump portion 3C, which is one of the pump portions 3C and 3D positioned on the vertically upper side, is disposed from the first recessed portion 80A into the housing 8, and the pump portion 3D, which is the other of the pump portions 3C and 3D positioned on the vertically upper side, is disposed from the second recessed portion 80B into the housing 8. Respectively assigning the openings of the pump portions 3C and 3D to the recessed portions 80A and 80B in this manner facilitates disposing the pump portions 3A to 3E at the generally even intervals in the direction around the central axis O.

(Reservoir Function)

The first fluid pool chamber 83 is replenished with the brake fluid from the reservoir tank 4 via the pipe 10R, and also functions as the reservoir (an internal reservoir) to supply the brake fluid to the intake port 823 of each of the pump portions 3A to 3E. Each of the pump portions 3A to 3E introduces and discharges the brake fluid via the first fluid pool chamber 83. The first fluid pool chamber 83 has a cylindrical shape, and a radial cross-sectional area thereof is larger than a cross-sectional area of the flow passage of the intake fluid passage 12 opened to the first fluid pool chamber 83. In other words, the first fluid pool chamber 83 is a volume chamber above the intake fluid passage 12. When the brake fluid leaks from the intake pipe 10R due to, for example, a detachment of the intake pipe 10R from the nipple 10R1 or 10R2 or loosening of a band fastening the intake pipe 10R to the nipple 10R1 or 10R2, the first fluid pool chamber 83 functions as the reservoir storing the brake fluid therein. The pump 3 can generate the wheel cylinder hydraulic pressures and can generate a braking torque on the vehicle on which the brake system 1 is mounted by introducing the brake fluid from the first fluid pool chamber 83 and discharging the brake fluid. When the fluid leaks from the intake pipe 10R, the present embodiment can secure the brake fluid in the first chambers 43P and 43S although the brake fluid reduces in the second chamber 43R of the reservoir tank 4, thereby continuously realizing the pressing force brake.

The intake port 873 may be connected to the first fluid pool chamber 83 via a fluid passage (having a smaller cross-sectional area of the flow passage than the radial cross-sectional area of the first fluid pool chamber 83). In the present embodiment, the intake port 873 is directly connected to the first fluid pool chamber 83. In other words, the first fluid pool chamber 83 is disposed from the top surface 804 into the housing 8. The opening portion of the first fluid pool chamber 83 functions as the intake port 873. Therefore, the present embodiment allows the first fluid pool chamber 83 to be disposed as close to the surface (the top surface 804) side of the housing 8 as possible, thereby succeeding in securing a large substantial volume of the first fluid pool chamber 83. The first fluid pool chamber 83 is disposed on the vertically upper side with respect to the intake port 823 of each of the pump portions 3A to 3E. Therefore, the present embodiment allows the brake fluid to be easily supplied from the first fluid pool chamber 83 to the intake port 823 of each of the pump portions 3A to 3E via the intake fluid passage 12 with the aid of a weight of the brake fluid itself. Further, the present embodiment prevents or reduces retention of air inside the intake fluid passage 12, thereby preventing or reducing an intake of air (air bubbles) by the pump 3. The intake port 873 does not have to be opened on the top surface 804, and may be opened on, for example, the right side surface 806. In the present embodiment, the intake port 873 is opened on the top surface 804. Therefore, the first fluid pool chamber 83 is disposed on the vertically upper side of the housing 8, which facilitates disposing the first fluid pool chamber 83 on the vertically upper side with respect to the intake port 823 of each of the pump portions 3A to 3E.

(Drain Function)

The brake fluid leaks out from each of the cylinder containing holes 82 to the cam containing hole 81 via the first seal ring 34. For example, the brake fluid leaks out from the intake-side space R1 by passing through the gap between the plunger 36 and the first seal ring 34. The brake fluid leaking out to the cam containing hole 81 is introduced into the second fluid pool chamber 84 via the drain fluid passage 19 and stored in the chamber 84. Therefore, the present embodiment can prevent or reduce entry of the brake fluid located in the cam containing hole 81 into the motor 20, thereby succeeding in improving operability of the motor 20. The chamber 84 is disposed on the Z-axis negative direction side with respect to the cam containing hole 81. Therefore, the present embodiment allows the brake fluid leaking out from each of the cylinder containing holes 82 to the cam containing hole 81 to be transmitted from the cam containing hole 81 to the chamber 84 with the aid of the weight of the brake fluid itself. As a result, the present embodiment allows the above-described brake fluid leaking out to the chamber 84 to be efficiently stored. The chamber 84 is opened on the bottom surface 803, and is disposed from the bottom surface 803 into the housing 8. Therefore, the present embodiment allows the chamber 84 to be disposed as close to one side where the bottom surface 803 is located as possible, thereby succeeding in securing a large substantial volume of the chamber 84. The opening of the chamber 84 is closed by a cover member 840. The cover member 840 may be provided in such a manner that a position thereof in the Z-axis direction relative to the housing 8 (the bottom surface 803) is adjustable with use of, for example, a screw. As a result, the present embodiment can change the substantial volume of the chamber 84.

(Size Reduction and Improvement of Layout Efficiency)

The brake system 1 includes the first unit 1A and the second unit 1B. Therefore, the present embodiment can improve mountability of the brake system 1 onto the vehicle. The stroke simulator 6 is disposed on the first unit 1A. Therefore, the present embodiment can reduce a length of the pipe connecting the master cylinder 5 or the second unit 1B and the stroke simulator 6 to each other and can also reduce the number of pipes compared when the stroke simulator 6 is a separate member from the master cylinder 5 or the second unit 1B. Therefore, the present embodiment can prevent or reduce complication of the brake system 1, and can also prevent or cut down a cost increase accompanying the increase in the number of pipes. The stroke simulator 6 is disposed on the first unit 1A, and the master cylinder 5 and the stroke simulator 6 are integrated as the first unit 1A. Therefore, the present embodiment can prevent or cut down an increase in the size of the second unit 1B compared to when the stroke simulator 6 is disposed on the second unit 1B. The pipe connecting the stroke simulator 6 and the second unit 1B to each other does not include a pipe connecting the positive pressure chamber 601 and the second unit 1B to each other, and includes only the backpressure pipe 10X connecting the backpressure chamber 602 and the second unit 1B to each other. Therefore, the present embodiment can reduce the number of pipes connecting the first unit 1A (the stroke simulator) and the second unit 1B to each other.

The electromagnetic valves, the hydraulic sensor 91, and the like are disposed on the second unit 1B. Therefore, the present embodiment does not require an ECU for driving the electromagnetic valves on the first unit 1A, and neither requires a wiring (a harness) for controlling the electromagnetic valves and transmitting sensor signals between the first unit 1A and the ECU 90 (the second unit 1B). Therefore, the present embodiment can prevent or reduce the complication of the brake system 1, and can also prevent or cut down a cost increase accompanying an increase in the number of pipes. Further, since no ECU is disposed on the first unit 1A, the present embodiment can reduce a size of the first unit 1A and improve layout flexibility thereof. For example, the SS/V IN 27 and the like are disposed on the second unit 1B. Therefore, the present embodiment does not require an ECU for switching the activation of the stroke simulator 6 on the first unit 1A, and neither requires a wiring (a harness) for controlling the SS/V IN 27 and the SS/V OUT 28 between the first unit 1A and the ECU 90 (the second unit 1B). The ECU 90 is attached to the housing 8, and the ECU 90 and the housing 8 (containing the electromagnetic valves and the like) are integrated as the second unit 1B. Therefore, the present embodiment can omit a wiring (a harness) connecting the electromagnetic valves, the hydraulic sensor 91, and the like, and the ECU 90 to each other. More specifically, the terminals of the solenoids of the electromagnetic valves 21 and the like, and the terminals of the hydraulic sensor 91 and the like are directly connected to the control board (without intervention of a harness and a connector outside the housing 8). Therefore, for example, the present embodiment can omit a harness connecting the ECU 90 and the SS/V IN 27 and the like to each other. The motor 20 is disposed on the first unit 1B, and the housing 8 (containing the pump 3 therein) and the motor 20 are integrated as the second unit 1B. This second unit 1B functions as a pump apparatus. Therefore, the present embodiment can omit a wiring (a harness) connecting the motor 20 and the ECU 90 to each other. More specifically, the conductive member for supplying power and transmitting signals to the motor 20 is contained in the power source hole 86 of the housing 8, and is directly connected to the control board (without intervention of a harness and a connector outside the housing 8). The conductive member functions as the connection member connecting the control board and the motor 20 to each other.

The housing 8 is sandwiched between the motor 20 and the ECU 90. In other words, the motor 20, the housing 8, and the ECU 90 are disposed so as to be arranged in this order along the axial direction of the motor 20. More specifically, the ECU 90 is attached to the back surface 802 opposite from the front surface 901 to which the motor 20 is attached. Therefore, the motor 20 and the ECU 90 can be disposed so as to overlap each other as viewed from one side where the motor 20 is located or the other side where the ECU 90 is located (as viewed from the Z-axis direction). As a result, the present embodiment can reduce the area of the second unit 1B as viewed from the one side where the motor 20 is located or the other side where the ECU 90 is located, thereby succeeding in a reduction in the size of the second unit 1B. The present embodiment can achieve a reduction in a weight of the second unit 1B due to the reduction in the size of the second unit 1B.

The connector portion 903 of the ECU 90 is adjacent to the housing 8 (the left side surface 905) as viewed from the Z-axis positive direction side. In other words, the connector portion 903 is not covered by the housing 8 and protrudes from the left side surface 805 of the housing 8 as viewed from the one side where the motor 20 is located. Therefore, the control board of the ECU 90 can be extended to not only a region overlapping the housing 8 but also a region overlapping the connector portion 903 (a region adjacent to the left side surface 805) as viewed from the one side where the motor 20 is located. The bolts b2 for attaching the ECU 90 to the back surface 802 are not fixed to the housing 8 by penetrating through the ECU 90 from the other side where the back surface 802 (the ECU 90) is located but are fixed by penetrating through the housing 8 from the one side where the front surface 801 is located. If the bolts b2 penetrate through the ECU 90 (the control board), the control board would be unable to be disposed at a portion through which these bolts b2 penetrate. Further, if the control board is also disposed on a back of the connector portion 903, the control board would be unable to be disposed in proximity to the portion through which the bolts b2 penetrate. The incapability to dispose the control board makes it impossible to lay a wiring pattern and mount an element at this portion. In other words, an area where the control board is implemented reduces. Providing the bolts b2 so as to penetrate through the housing 8 without penetrating through the ECU 90 can eliminate a portion where the bolts b2 and the control board would otherwise interfere with each other. Therefore, the present embodiment can secure a wide area where the control board is implemented, and easily deal with multi-functionalization of the ECU 90.

The terminal of the connector portion 903 extends in the Y-axis direction. Therefore, the present embodiment can prevent or cut down an increase in a dimension of the second unit 1B as viewed from the Y-axis direction (in the X-axis direction). The terminal of the connector portion 903 is exposed toward the one side where the motor 20 is located (the Y-axis positive direction side). Therefore, the connector (the harness) connected to the connector portion 903 overlaps the housing 8 and the like in the axial direction of the motor 20 (the Y-axis direction), whereby the present embodiment can prevent or cut down an increase in a dimension of the second unit 1B including this connector (the harness) in the Y-axis direction (the axial direction of the motor 20). The connector portion 903 is adjacent to the left side surface 805 of the housing 8. Therefore, the present embodiment can prevent or reduce interference between the connector (the harness) connected to the connector portion 903 and the pipes 10M and 10W respectively connected to the ports 871 and 872 compared when the connector portion 903 is adjacent to the top surface 904 of the housing 8. Further, the present embodiment can prevent or reduce interference between the vehicle body-side member (the mount 100) that the bottom surface 803 faces and the above-described connector (the harness) compared to when the connector portion 903 is adjacent to the bottom surface 803 of the housing 8. The rotational driving shaft 300 extends in the horizontal direction (y-axis direction) in the state mounted on the vehicle. Therefore, the connector portion 903 extends in the horizontal direction in the state mounted on the vehicle. As a result, the present embodiment can prevent or reduce entry of water into the connector portion 903 while securing connectivity of the harness to the connector portion 903. The connector portion 903 may be adjacent to the right side surface 806 of the housing 8. In the present embodiment, the connector portion 903 is adjacent to the left side surface 805. A port or the like, such as the backpressure port 874, is not formed on the left side surface 805. Therefore, the present embodiment can prevent or reduce interference between the connector (the harness) connected to the connector portion 903 and the pipe 10X connected to the backpressure port 874 compared to when the connector portion 903 is adjacent to the right side surface 806. In other words, when the connector (the harness) is connected to the connector portion 903, the present embodiment facilitates the connection thereof. Therefore, the present embodiment can improve mounting workability of the brake system 1 onto the vehicle.

The plurality of pump portions 3A to 3E overlap one another in the axial direction of the rotational driving shaft 300. The cylinder containing holes 82A to 82E are arrayed in one row along the axial direction of the motor 20. More specifically, the central axes 360 of the cylinder containing holes 82A to 82E are located on the generally same plane α generally orthogonal to the central axis O. Therefore, the present embodiment can allow the cam unit 30 to be used by the plurality of plungers 36 in common to thus prevent or cut down an increase in the number of cam units 30, thereby preventing or cutting down increases in the number of parts and the cost. Further, the present embodiment can shorten the rotational driving shaft 300 to prevent or cut down an increase in a dimension of the housing 8 in the axial direction of the motor 20 by preventing or cutting down the increase in the number of cam units 30. As a result, the present embodiment can achieve reductions in the size and the weight of the second unit 1B. Further, the present embodiment can further effectively prevent or cut down the increase in the dimension of the housing 8 in the axial direction of the motor 20 by maximizing a range where the individual cylinder containing holes 82A to 82E overlap one another in the Y-axis direction. The cylinder containing holes 82 are disposed on the front surface 801 side of the housing 8 (the one side where the motor 20 is mounted). Therefore, the present embodiment can further shorten the rotational driving shaft 300. Further, the present embodiment can simplify a layout of the fluid passages due to the plurality of pump portions 3A to 3E overlapping one another in the axial direction of the rotational driving shaft 300. Therefore, the present embodiment can prevent or cut down the increase in the size of the housing 8.

The housing 8 includes the plurality of cylinder containing holes 82 containing the plungers 36 of the pump 3 therein, and the plurality of valve containing holes containing the valve bodies of the electromagnetic valves 21 and the like therein. These cylinder containing holes 82 and the valve containing holes at least partially overlap each other as viewed from the Y-axis direction. Therefore, the present embodiment can reduce the area of the second unit 1B as viewed from the one side where the motor 20 is located. The plurality of cylinder containing holes 82 is provided radially around the central axis O of the motor 20. Therefore, the present embodiment facilitates provision of the region where the individual cylinder containing holes 82A to 82E overlap one another in the axial direction of the motor 20. Most of the plurality of valve containing holes is contained in the circle connecting the ends of the cylinder containing holes 82 on the large-diameter portion 821 side (the other side farer away from the central axis O) as viewed from the Y-axis direction. Alternatively, the outer periphery of this circle and the valve containing holes at least partially overlap each other. Therefore, the present embodiment can reduce the area of the second unit 1B as viewed from the Y-axis direction.

The plurality of valve containing holes is arrayed in one row along the axial direction of the motor 20. Therefore, the present embodiment can prevent or cut down the increase in the dimension of the housing 8 in the axial direction of the motor 20. The valve containing holes are disposed on the other side of the housing 8 where the back surface 802 is located (the other side where the ECU 90 is attached). Therefore, the present embodiment can improve electric connectivity between the ECU 90 and the solenoids of the electromagnetic valves 21 and the like. More specifically, the central axes of the plurality of valve containing holes extend generally in parallel with the central axis of the motor 20, and all the valve containing holes are opened on the back surface 802. Therefore, the present embodiment allows the solenoids of the electromagnetic valves 21 and the like to be concentrated on the back surface 802 of the housing 8, thereby succeeding in simplification of the electric connections between the ECU 90 and the solenoids. Similarly, the plurality of sensor containing holes is disposed on the back surface 802 side. Therefore, the present embodiment can improve electric connectivity between the ECU 90 and the hydraulic sensor 91 and the like. The control board of the ECU 90 is disposed generally in parallel with the back surface 802. Therefore, the present embodiment can simplify the electric connection between the ECU 90 and the solenoids (and the sensors).

The housing 8 includes a pump region (a pump portion) and an electromagnetic valve region (an electromagnetic valve portion) in this order from the front surface 801 side to the back surface 802 side along the axial direction of the motor 20. The region where the cylinder containing holes 82 are positioned is the pump region and the region where the valve containing holes are positioned is the electromagnetic valve region along the axial direction of the motor 20. The present embodiment can easily prevent or cut down the increase in the dimension of the housing 8 in the axial direction of the motor 20 by concentrating the cylinder containing holes 82 and the valve containing holes for each of the regions in the axial direction of the motor 20 in this manner. Further, the present embodiment can improve the layout efficiency of each of the elements of the housing 8 and achieve the reduction in the size of the housing 8. In other words, the present embodiment increases the layout flexibility of the plurality of holes in the plane orthogonal to the central axis of the motor 20 in each of the regions. For example, the present embodiment facilitates disposing the plurality of valve containing holes in the electromagnetic valve region so as to prevent or cut down the increase in the dimension of the housing 8 in the above-described plane. These regions may partially overlap each other in the axial direction of the motor 20.

The recessed portions 80A and 80B are formed at the corner portions on the one side and the other side of the housing 8 where the front surface 801 and the top surface 804 are located, respectively. Therefore, the one side and the other side of the housing 8 where the front surface 801 and the top surface 804 are located, respectively, are reduced in volume and thus reduced in weight by amounts corresponding to the recessed portions 80A and 80B. In this manner, the present embodiment can reduce the volume and the weight of the housing 8. The two cylinder containing holes 82C and 82D on the Z-axis positive direction side are disposed on both the opposite sides of the central axis O from each other in the X-axis direction. Therefore, the cylinder containing holes 82 are not opened in the vicinity of the central axis O (the center in the X-axis direction) on the top surface 804, whereby the present embodiment can prepare a large space where the other hole (the first fluid pool chamber 83) is opened. The wheel cylinder ports 872 are opened on the top surface 804. Therefore, the present embodiment can save the space of the front surface 801 and facilitate the formation of the recessed portions 80A and 80B at the corner portions of the housing 8 compared to when the ports 872 are opened on the front surface 801. The ports 872 are disposed on the Y-axis negative direction side of the top surface 804. Therefore, the present embodiment can facilitate the connection between the ports 872 and the SOL/V IN containing holes and the like while avoiding interference between the ports 872 and the cylinder containing holes 82, thereby simplifying the fluid passages, by disposing the ports 872 in the electromagnetic valve region. The four ports 872 are disposed so as to be arranged in the X-axis direction on the Y-axis negative direction side of the top surface 804. Therefore, the present embodiment can prevent or cut down the increase in the dimension of the housing 8 in the Y-axis direction by arranging the ports 872 in one row in the Y-axis direction.

The master cylinder ports 871 are opened on the front surface 801. Therefore, the present embodiment can save the space of the top surface 804 and facilitate the formation of the wheel cylinder ports 872 and the like on the top surface 804 compared to when the ports 871 are opened on the top surface 804. The ports 871 are disposed on the Z-axis positive direction side of the front surface 801 with respect to the central axis O. The ports 871 are located on the Z-axis positive direction side with respect to the motor housing 200, and overlap the motor housing 200 in the X-axis direction (as viewed from the Z-axis direction). Therefore, the present embodiment can prevent or cut down an increase in a dimension of the front surface 801 in the X-axis direction. The ports 871P and 871S sandwich the first fluid pool chamber 83 in the X-axis direction (as viewed from the Y-axis direction). In other words, the first fluid pool chamber 83 is disposed between the ports 871P and 871S in the X-axis direction. The present embodiment can improve the layout efficiency inside the housing 8 and can also reduce the area of the front surface 801, thereby achieving the reduction in the size of the housing 8, by utilizing the space between the ports 871P and 871S to form the first fluid pool chamber 83 in this manner. The individual ports 871P and 871S are sandwiched between the first fluid pool chamber 83 and the cylinder containing holes 82C and 82D, respectively, in the direction around the central axis O (as viewed from the Y-axis direction). Therefore, the present embodiment can prevent or cut down an increase in a dimension from the central axis O to the outer surface (the top surface 804) of the housing 8, thereby achieving the reduction in the size of the housing 8. Further, the present embodiment allows the opening portions of the ports 871 on the front surface 801 to be disposed on the central side in the X-axis direction, thereby facilitating the formation of the recessed portions 80A and 80B outside the ports 871P and 871S in the X-axis direction.

The backpressure port 874 is opened on the right side surface 806. Therefore, the present embodiment can save the space of the front surface 801 or the top surface 804 compared to when the port 874 is opened on the front surface 801 or the top surface 804. Therefore, the present embodiment can prevent or cut down the increase in the area of the front surface 801 or the top surface 804, thereby preventing or cutting down the increase in the size of the housing 8. The port 874 is opened on the right side surface 806. The connector portion 903 is not adjacent to the right side surface 806. Therefore, the present embodiment can prevent or reduce the interference between the connector (the harness) connected to the connector portion 903 and the pipe 10X connected to the port 874 compared to when the port 874 is adjacent to the left side surface 805. In other words, when the pipe 10X is connected to the port 874, the present embodiment facilitates the connection thereof. Therefore, the present embodiment can improve the mounting workability of the brake system 1 onto the vehicle.

The intake port 873 is opened on the Y-axis positive direction side (the pump region) on the top surface 804. Therefore, the present embodiment facilitates the connection of the cylinder containing holes 82 (the intake ports 823 of the pump portions 3C and 3D) to the port 873 (the first fluid pool camber 83), thereby succeeding in simplifying the fluid passages. The port 873 is opened on the central side in the X-axis direction on the top surface 804. Therefore, in the case where the single first fluid pool chamber 83 is used for both the P and S systems in common, the present embodiment facilitates the connection of the port 873 (the chamber 83) to the valve containing holes of both the systems, thereby succeeding in simplifying the fluid passages. The wheel cylinder ports 872c and 872d sandwich the intake port 873 (the first fluid pool chamber 83), and the openings of the ports 872c and 872d and the intake port 873 (the first fluid pool chamber 83) partially overlap each other in the X-axis direction (as viewed from the Y-axis direction). Therefore, the present embodiment can prevent or cut down the increase in the dimension of the housing 8 in the X-axis direction, thereby achieving the reduction in the size.

The first fluid pool chamber 83 is opened on the outer surface of the housing 8. More specifically, a radial cross section of the first fluid pool chamber 83 is opened on the surface (the top surface 804) of the housing 8. Therefore, the present embodiment eliminates the necessity of a thickness around the first fluid pool chamber 83 (especially on the surface side of the housing 8 in the axial direction of the first fluid pool chamber 83) compared to when the first fluid pool chamber 83 is connected to the intake port 873 (the top surface 804) via the fluid passage (having a smaller cross-sectional area of the fluid passage than a radial cross-sectional area of the first fluid pool chamber 83). As a result, the present embodiment can improve the layout efficiency (volume efficiency) inside the housing 8. Further, the present embodiment simplifies handling of the fluid passage from the intake port 873 (the top surface 804) to the first fluid pool chamber 83. Therefore, the present embodiment can facilitate processing of the housing 8 and also achieve the reduction in the size of the housing 8. The intake port 873 does not have to be opened on the top surface 804. For example, with the central axis of the first fluid pool chamber 83 extending in the Y-axis direction and the first fluid pool chamber 83 opened on the front surface 801 on the Y-axis positive direction side, this opening portion may function as the intake port 873. In the present embodiment, with the central axis of the first fluid pool chamber 83 extending in the direction orthogonal to the central axis O and the first fluid pool chamber 83 opened on the outer surface (the top surface 804) of the housing 8 intersecting with this direction (extending along the direction around the central axis O), this opening portion functions as the intake port 873. Therefore, the present embodiment can prevent or cut down the increase in the dimension from the central axis O to the outer surface (the top surface 804 on which the first fluid pool chamber 83 is opened) of the housing 8 extending along the direction around the central axis O, thereby succeeding in the reduction in the size of the housing 8.

The first fluid pool chamber 83 is formed in the region between the cylinder containing holes 82C and 82D adjacent to each other in the direction around the central axis O. Therefore, the present embodiment can shorten the intake fluid passage 12 connecting the chamber 83 and the intake ports 823 of the pump portions 3C and 3D to each other. Further, the present embodiment can prevent or cut down an increase in a dimension from the central axis O to the outer surface (the top surface 804 on which the chamber 83 is opened) of the housing 8 extending along the direction around the central axis O, thereby achieving the reduction in the size of the housing 8, by disposing the chamber 83 closer to the central axis O. In other words, the present embodiment can improve the layout efficiency (the volume efficiency) inside the housing 8 and can also reduce the area of the front surface 801, thereby achieving the reduction in the size of the housing 8, by utilizing the space between the holes 82C and 82D to form the chamber 83. The present embodiment can reduce the space between the chamber 83 (the bottom portion thereof) and the hole 81, thereby improving the above-described layout efficiency, by disposing the chamber 83 closer to the cam containing hole 81. The power source hole 86 is formed in the region between the holes 82C and 82D adjacent to each other in the direction around the central axis O. Therefore, the present embodiment can improve the layout efficiency (the volume efficiency) inside the housing 8 and can also reduce the area of the front surface 801, thereby achieving the reduction in the size of the housing 8, by utilizing the space between the holes 82C and 82D to form the power source hole 86. The present embodiment can further improve the above-described layout efficiency by disposing the space between the hole 86 and the hole 81 of the chamber 83 (the bottom portion thereof). The holes 82C and 82D and the chamber 83 partially overlap each other in the Y-axis direction (as viewed from the X-axis direction). Therefore, the present embodiment can prevent or cut down the increase in the dimension of the housing 8 in the Y-axis direction, thereby achieving the reduction in the size. The chamber 83 is disposed in the region surrounded by the master cylinder ports 871P and 871S and the wheel cylinder ports 872c and 872d. More specifically, the chamber 83 overlaps each of the above-described port 871P and the like in the Z-axis direction, and is also located inside a quadrilateral defined by connecting the above-described port 871P and the like with line segments as viewed from the Z-axis direction. The present embodiment can improve the layout efficiency inside the housing 8 and can also achieve the reduction in the size of the housing 8, by utilizing the space between the above-described port 871P and the like to form the chamber 83 in this manner.

The second fluid pool chamber 84 does not have to be opened on the bottom surface 803. For example, the central axis of the chamber 84 may extend in the Y-axis direction, and the chamber 84 may be opened on the front surface 801 on the Y-axis positive direction side. In the present embodiment, the central axis of the chamber 84 extends in the direction orthogonal to the central axis O, and the chamber 84 is opened on the outer surface (the bottom surface 803) of the housing 8 intersecting with this direction (extending along the direction around the central axis O). Therefore, the present embodiment can prevent or cut down the increase in the dimension from the central axis O to the outer surface (the bottom surface 803 on which the chamber 84 is opened) of the housing 8 extending along the direction around the central axis O, thereby achieving the reduction in the size of the housing 8. The chamber 84 is formed in the region between the cylinder containing holes 82B and 82C adjacent to each other in the direction around the central axis O. Therefore, the present embodiment can prevent or cut down the increase in the dimension from the central axis O to the outer surface (the bottom surface 803 on which the chamber 84 is opened) of the housing 8 extending along the direction around the central axis O, thereby achieving the reduction in the size of the housing 8, by disposing the chamber 84 closer to the central axis O. In other words, the present embodiment can improve the layout efficiency (the volume efficiency) inside the housing 8 and can also reduce the area of the front surface 801, thereby achieving the reduction in the size of the housing 8, by utilizing the space between the holes 82B and 82C to form the chamber 84. The present embodiment can reduce the space between the chamber 84 (the bottom portion thereof) and the hole 81, thereby improving the above-described layout efficiency, by disposing the chamber 84 closer to the cam containing hole 81. The holes 82A to 82E and the chamber 84 partially overlap each other in the Y-axis direction (as viewed from the X-axis direction). Therefore, the present embodiment can prevent or cut down the increase in the dimension of the housing 8 in the Y-axis direction, thereby achieving the reduction in the size. The chamber 84 is opened on the Y-axis positive direction side on the bottom surface 803. Therefore, the present embodiment can facilitate the connection of the chamber 84 to the region in the cam containing hole 81 where the holes 82A to 82E are opened, thereby simplifying the drain fluid passage 19.

The bolt holes 858A and 858B are disposed on the front surface 801 on the Z-axis negative direction side with respect to the central axis O. The holes 858A and 858B are fixed with use of the bolts B2, and the collar member 106 and the insulators 108 are attached around the bolts B2. These insulators 108 and the like overlap the motor housing 200 in the X-axis direction and the Z-axis direction (as viewed from the Y-axis direction). Therefore, the present embodiment can efficiently utilize the space on the front surface 801 on the Z-axis negative direction side with respect to the central axis O, thereby preventing or cutting down the increases in the dimensions of the front surface 801 in the X-axis direction and the Z-axis direction. Further, the holes 858A and 858B are disposed on the front surface 801 on the Z-axis negative direction side with respect to the central axis O, whereby the present embodiment can reduce the size of the second mount portion 102, which is an arm portion of the mount 100, thereby improving the mountability of the second unit 1B.

(Improvement of Supportability and Prevention or Reduction of Vibration)

The center of gravity of the second unit 1B is slightly offset from the center of gravity of the housing 8 to one side where the connector portion 903 is located (to the X-axis negative direction side) in the X-axis direction due to the provision of the connector portion 903. The center of gravity of the second unit 1B is offset from the central gravity of the housing 8 to the one side where the motor 20 is located (to the Y-axis positive direction side) in the Y-axis direction due to the provision of the motor 20. The center of gravity of the second unit 1B is offset from the center of gravity of the housing 8 to the vertically lower side (to the Z-axis positive direction side) in the Z-axis direction because, for example, the central axis O of the rotational driving shaft 300 is provided on the Z-axis negative direction side with respect to the center of the housing 8 in the Z-axis direction, and, further, the number of pump portions 3A, 3B, and 3E positioned on the Z-axis negative direction side is larger than the number of pump portions 3C and 3D positioned on the Z-axis positive direction side with respect to the central axis O.

The housing 8 (the second unit 1B) is fixed to the vehicle body side via the mount 100. Therefore, the present embodiment can improve supportability of the structure supporting the housing 8. The second unit 1B can be stably held by supporting the bottom surface 803 and the front surface 801 of the housing 8 in the following manner. The support portion of the bottom surface 803 and the support portion of the front surface 801 support the housing 8 in directions different from each other, whereby the present embodiment can improve support strength with respect to a load possibly applied to the housing 8 in multiple directions. More specifically, the pin hole 859 for the fixation to the mount 100 is provided on the bottom surface 803 of the housing 8. The pin hole 859 is opened on the bottom surface 803 and extends vertically. The pin PIN fixed in the hole 859, and the insulator 105 attached to the pin PIN also extend vertically. Therefore, the insulator 105 receives the weight of the second unit 1B (a load due to a gravitational force applied vertically downward) in the axial direction thereof and efficiently supports this vertical load, whereby the present embodiment can stably support the second unit 1B with respect to the vehicle body side (the mount 100). Preferably, rubber highly resistant to axial compression is used for the insulator 105. The bolt holes 858A and 858B for the fixation to the mount 100 are provided on the vertically lower side on the front surface 801 of the housing 8 with respect to the central axis O. The holes 858A and 858B are opened on the front surface 801, and extend horizontally. The bolts B2 fixed in the holes 858A and 858B and the insulators 108 attached to the bolts B2 also extend horizontally. The center of gravity of the second unit 1B is offset from the center of gravity of the housing 8 to the one side where the front surface 801 is located. The second unit 1B tends to be tilted to the one side where the front surface 801 is located due to the weight of the motor 20. The insulators 108 receive, in the axial direction thereof, the load of the second unit 1B that is applied in a direction of the above-described tilt, and efficiently support this horizontal load, whereby the present embodiment can stably support the second unit 1B with respect to the vehicle body side (the mount 100). Preferably, rubber highly resistant to axial compression is used for the insulators 108. The center of gravity of the second unit 1B is positioned on the vertically lower side, whereby the present embodiment can improve installation stability of the second unit 1B. The first recessed portion 80A and the second recessed portion 80B are opened on the top surface 804. One side of the housing 8 where the top surface 804 is located is reduced in weight by the amount corresponding to the recessed portions 80A and 80B. Therefore, the present embodiment can allow the center of gravity of the second unit 1B to be easily positioned on the vertically lower side.

The two bolt holes 858A and 858B are opened on the front surface 801. Therefore, the present embodiment can further stably support the second unit 1B by supporting the housing 8 on two points. Further, the present embodiment can reduce a load applied to around each of the holes 858A and 858B by supporting the load of the second unit 1B while further distributing it to the two holes 858A and 858B (the bolts B2). The present embodiment can reduce a dimension of each of the holes 858A and 858B, thereby achieving the reduction in the size of the housing 8. The holes 858A and 858B are disposed on the front surface 801 on both the opposite sides of the central axis O from each other in the X-axis direction. The center of gravity of the second unit 1B is positioned near the central axis O in the X-axis direction. Therefore, the present embodiment can further stably support the second unit 1B by fixing the housing 8 on the opposite sides of the above-described center of gravity from each other in the X-axis direction. The holes 858A and 858B are disposed at the ends of the front surface 801 on the both sides in the X-axis direction. Therefore, the present embodiment can further stably support the second unit 1B by increasing a distance between the two support points. Further, the present embodiment can further reduce the loads applied to around the holes 858A and 858B by increasing distances from the center of gravity of the second unit 1B to the holes 858A and 858B in the X-axis direction. The hole 859 is disposed on the Y-axis negative direction side of the bottom surface 803. Therefore, the present embodiment can further stably support the second unit 1B by increasing a distance between the support portion of the front surface 801 (the portion where the front surface 801 is attached to the second mount portion 102) and the support portion of the bottom surface 803 (the portion where the bottom surface 803 is attached to the first mount portion 101).

The rotational force of the motor 20 is applied to the motor housing 200 and the housing 8 as a reaction force via the motor rotational shaft and the bearing of the rotational driving shaft 300. Due to this reaction force, a vibration can occur in the second unit 1B in the direction around the central axis O when the motor 20 (the pump 3) is activated. Further, in each of the pump portions 3A to 3E, the plunger 36 reciprocates in the axial direction of each of the pump portions 3A to 3E. The pump portions 3A to 3E become a source from which the vibration of the housing 8 is generated (a vibration generation source). The number of pump portions 3A, 3B, and 3E positioned on the vertically lower side with respect to the central axis O (three) is larger than the number of pump portions 3C and 3D positioned on the vertically upper side with respect to the central axis O of the rotational driving shaft 300 (two) with the housing 8 mounted on the vehicle. Therefore, the vibration easily increases on the vertically lower side of the second unit 1B. The above-described vibration can be transmitted from the second unit 1B to the vehicle body side via the mount 100. Further, the vibration of the second unit 1B can be transmitted to the first unit 1A via the metallic pipes 10M and 10X and further transmitted to the dash panel on the vehicle body side via the flange portion 78. The transmission of the vibration to the dash panel may cause occurrence of noise in the vehicle compartment. Further, in a case where a sensor for detecting the motion state of the vehicle (for example, the angular speed sensor, hereinafter referred to as a behavior sensor) is mounted inside the ECU 90 (the control board), the behavior sensor may incorrectly detect the above-described vibration of the second unit 1B as a motion of the vehicle body (for example, a yaw rate), so that detection accuracy of the behavior sensor may be deteriorated.

In the present embodiment, the housing 8 is supported on the vertically lower side with respect to the central axis O in the state mounted on the vehicle. Therefore, a larger number of pump portions (three: 3A, 3B, and 3E) among the pump portions 3A to 3E, which are the vibration generation source, are located closer to the support portion of the housing 8. In other words, the housing 8 is supported in a region where the vibration easily increases. Therefore, the present embodiment more effectively prevent or reduce the vibration of the second unit 1B than when the housing 8 is supported in a region where the vibration does not easily increase. Further, the first and second recessed portions 80A and 80B are opened on the top surface 804. The one side of the housing 8 where the top surface 804 is located is reduced in weight by the amount corresponding to the recessed portions 80A and 80B. The one side of the housing 8 where the top surface 804 is located is the vertically upper side with respect to the central axis O and is not supported by the support portion. The portion where the housing 8 is not supported is reduced in weight in this manner, which prevents or reduces the vibration of the second unit 1B. Along with the success in preventing or reducing the above-described vibration of the second unit 1B, the present embodiment can reduce the vibration to be transmitted to the vehicle body side via the mount 100, thereby achieving the quietness in the vehicle compartment. The housing 8 (the second unit 1B) is supported on the vehicle body side (the mount 100) via the insulators 105 and 108. The insulators 105 and 108 absorb the above-described vibration that has occurred along with the activation of the second unit 1B. As a result, the present embodiment can further effectively prevent or reduce the transmission of the above-described vibration from the second unit 1B to the vehicle body side via the mount 100. Further, along with the prevention or reduction of the above-described vibration of the second unit 1B, the present embodiment can reduce the vibration to be transmitted to the vehicle body side via the first unit 1A (the flange portion 78), thereby achieving the quietness in the vehicle compartment. Further, even in the case where the behavior sensor is mounted on the control board, the present embodiment can prevent or reduce the deterioration of the detection accuracy of the behavior sensor due to the prevention or reduction of the above-described vibration of the second unit 1B.

The pin hole 859 is opened on the bottom surface 803, and extends vertically. The bolt holes 858A and 858B are opened on the front surface 801, and extend horizontally. The support portion on the bottom surface 803 and the support portion on the front surface 801 support the housing 8 in the different directions from each other, whereby the present embodiment can improve the effect of preventing or reducing the vibration with respect to the vibration that can occur in the housing 8 in the multiple directions. The two bolt holes 858A and 858B are opened on the front surface 801. The housing 8 is supported at the two portions on the vertically lower side at least on the front surface 801, and therefore is supported with improved strength compared to when the housing 8 is supported at one portion on the vertically lower side. The housing 8 (the front surface 801) is supported at a plurality of positions in the region where the vibration easily increases, which effectively prevents or reduces the vibration of the second unit 1B. Further, the housing 8 is supported at the plurality of positions some distance away from one another in the direction around the central axis O, which effectively prevents or reduces the vibration of the second unit 1B in the direction around the central axis O. Further, the present embodiment can reduce the size of each of the insulators 105 by further distributing the vibration of the second unit 1B to the two insulators 105 to absorb it, thereby improving the mountability of the second unit 1B. The holes 858A and 858B are disposed on both the opposite sides of the central axis O from each other in the X-axis direction on the front surface 801. Therefore, the present embodiment can further effectively reduce the vibration around the central axis O of the second unit 1B by supporting the housing 8 on the opposite sides of the central axis O from each other in the X-axis direction. The holes 858A and 858B are disposed on the ends of the front surface 801 on the both sides in the X-axis direction. Therefore, the present embodiment can further effectively reduce the vibration of the second unit 1B by increasing the distance between the support points. The hole 859 is disposed on the Y-axis negative direction side of the bottom surface 803. Therefore, the present embodiment can further effectively reduce the vibration of the second unit 1B by increasing the distance between the support portion of the front surface 801 (the portion where the front surface 801 is attached to the second mount portion 102) and the support portion of the bottom surface 803 (the portion where the bottom surface 803 is attached to the first mount portion 101).

(Improvement of Workability)

The master cylinder ports 871 and the wheel cylinder ports 872 are disposed on the vertically upper side of the housing 8. Therefore, the present embodiment can improve the workability when the pipes 10MP, 10MS, and 10W are respectively attached to the ports 871 and 872 of the housing 8 that are set on the vehicle body side. The wheel cylinder ports 872 are opened on the top surface 804. Therefore, the present embodiment can further improve the above-described workability. The master cylinder ports 871 are opened on the end of the front surface 801 on the vertically upper side. Therefore, the present embodiment can further improve the above-described workability. Further, the intake port 873 in communication with the first fluid pool chamber 83 is disposed on the top surface 804, whereby the present embodiment facilitates the handling of the pipe connected to the intake port 873. Further, the present embodiment facilitates work from above at the time of the mounting onto the vehicle.

The ports 871 for connecting the master cylinder pipes 10M are located on the front surface 801. When each of the pipes 10M is fixed to the port 871, a nut is fastened with use of a tool. The tool approaches the front surface 801. If a part of the bolt b2 for attaching the ECU 90 to the back surface 802 protrudes into the front surface 801, this makes it difficult to fasten the nut with use of the tool. In the present embodiment, a part (the head portion) of the bolt b2 protrudes into each of the first recessed portion 80A and the second recessed portion 80B. In other words, the part of the bolt b2 does not protrude into the front surface 801 except for the recessed portions 80A and 80B. Therefore, interference between the part of the bolt b2 and the tool is prevented or reduced, whereby the present embodiment facilitates work of fixing the pipes 10M to the ports 871 with use of the tool. The cylinder containing holes 82C and 82D are opened to the recessed portions 80A and 80B, respectively. Therefore, the present embodiment can prevent or cut down increases in axial dimensions of the holes 82C and 82D, thereby improving efficiency of attaching the pump components into the holes 82C and 82D.

### Advantageous Effects

In the following description, advantageous effects of the present embodiment will be listed.

(1) The second unit 1B (a hydraulic control apparatus) includes the housing 8 including the fluid passages 11 and the like provided therein and configured to be mounted on the vehicle, the rotational driving shaft 300 provided inside the housing 8, and the plurality of pump portions 3A to 3E (a plurality of plunger pumps) configured to be activated by the rotation of the rotational driving shaft 300 and disposed in the direction around the central axis O of the rotational driving shaft 300 inside the housing 8. The pump portions 3A to 3E are provided in such a manner that the number of pump portions positioned on the vertically lower side is larger than the number of pump portions positioned on the vertically upper side with respect to the central axis O of the rotational driving shaft 300 with the housing 8 mounted on the vehicle.

Therefore, the present embodiment can further effectively reduce the vibration of the second unit 1B.

(2) The pump portions 3A to 3E (the plurality of plunger pumps) overlap one another in the axial direction of the rotational driving shaft 300.

Therefore, the present embodiment can prevent or cut down the increase in the number of parts of the second unit 1B, thereby achieving the reduction in the size of the second unit 1B.

(3) The pump portions 3A to 3E (the plurality of plunger pumps) each include the central axis 360 extending radially around the central axis O of the rotational driving shaft 300, and the straight line defined by extending the central axis 360 of the arbitrary pump portion 3A or the like beyond the central axis O of the rotational driving shaft 300 has the angle larger than zero degree in the direction around the central axis O of the rotational driving shaft 300 relative to the central axis 360 of another pump portion 3C, 3D, or the like.

Therefore, the present embodiment can reduce the pulse pressure.

(4) The pump portions 3A to 3E (the plurality of plunger pumps) include the two pump portions positioned on the vertically upper side and the three pump portions positioned on the vertically lower side with respect to the central axis O of the rotational driving shaft 300 with the housing 8 mounted on the vehicle.

Therefore, the present embodiment can improve the effect of reducing the pulse pressure while securing the discharge amount.

(5) The housing 8 includes the front surface 801 to which the motor 20 coupled with the rotational driving shaft 300 is attached, the back surface 802 opposite from the front surface 801, the bottom surface 803 connected to the front surface 801 and the back surface 802 and positioned on the vertically lower side with respect to the central axis O of the rotational driving shaft 300 with the housing 8 mounted on the vehicle, and the top surface 804 opposite from the bottom surface 803. At least one pump portion 3A of the three pump portions 3A, 3B, and 3E positioned on the vertically lower side is disposed from the bottom surface 803 into the housing 8.

Therefore, the present embodiment facilitates disposing the pump portions 3A, 3B, and 3E at the generally even intervals in the direction around the central axis O on the vertically lower side.

(6) The housing 8 includes the left side surface 805 (a first side surface) connected to the front surface 801, the back surface 802, the bottom surface 803, and the top surface 804, the right side surface 806 (a second side surface) opposite from the left side surface 805, the first recessed portion 80A opened on the front surface 801, the top surface 804, and the left side surface 805, and the second recessed portion 80B opened on the front surface 801, the top surface 804, and the right side surface 806. The pump portions 3C and 3D, which are the one and the other of the two pump portions 3C and 3D positioned on the vertically upper side, are disposed from the first recessed portion 80A and the second recessed portion 80B into the housing 8, respectively.

Therefore, the present embodiment facilitates disposing the pump portions 3A to 3E at the generally even intervals in the direction around the central axis O.

(7) The three pump portions 3A, 3B, and 3E positioned on the vertically lower side are disposed from the bottom surface 803, the left side surface 805 (the first side surface), and the right side surface 806 (the second side surface) into the housing 8, respectively.

Therefore, the present embodiment facilitates disposing the pump portions 3A, 3B, and 3E at the generally even intervals in the direction around the central axis O on the vertically lower side.

(12) The second unit 1B (a hydraulic control apparatus) includes the housing 8 including the fluid passages 11 and the like and the rotational driving shaft 300 (a rotational shaft) provided therein, the front surface 801 (a first surface), the back surface 802 (a second surface) opposite from the front surface 801, the bottom surface 803 (a third surface) connected to the front surface 801 and the back surface 802, the top surface 804 (a fourth surface) opposite from the bottom surface 803, the left side surface 805 (a fifth surface) connected to the front surface 801, the back surface 802, the bottom surface 803, and the top surface 804, the right side surface 806 (a sixth surface) opposite from the left side surface 805, the first recessed portion 80A opened on the front surface 801, the top surface 804, and the left side surface 805, and the second recessed portion 80B opened on the front surface 801, the top surface 804, and the right side surface 806. The housing 8 is configured in such a manner that the motor coupled with the rotational driving shaft 300 is attached to the front surface 801, and the bottom surface 803 is positioned on the vertically lower side with respect to the central axis O of the rotational driving shaft 300 and the first recessed portion 80A and the second recessed portion 80B are positioned on the vertically upper side with respect to the central axis O of the rotational driving shaft 300 with the housing 8 mounted on the vehicle. The second unit 1B further includes the pump portion 3A (a first plunger pump) disposed from the bottom surface 803 into the housing 8 and configured to be activated by the rotation of the rotational driving shaft 300, the pump portion 3B (a second plunger pump) disposed from the portion of the left side surface 805 that is positioned on the vertically lower side with respect to the central axis O of the rotational driving shaft 300 with the housing 8 mounted on the vehicle into the housing 8, and configured to be activated by the rotation of the rotational driving shaft 300, the pump portion 3C (a third plunger pump) disposed from the first recessed portion 80A into the housing 8 and configured to be activated by the rotation of the rotational driving shaft 300, the pump portion 3D (a fourth plunger pump) disposed from the second recessed portion 80B into the housing 8 and configured to be activated by the rotation of the rotational driving shaft 300, and the pump portion 3E (a fifth plunger pump) disposed from the portion of the right side surface 806 that is positioned on the vertically lower side with respect to the central axis O of the rotational driving shaft 300 with the housing 8 mounted on the vehicle into the housing 8, and configured to be activated by the rotation of the rotational driving shaft 300.

Therefore, the present embodiment can further effectively reduce the vibration of the second unit 1B. Further, the present embodiment can improve the effect of reducing the pulse pressure while securing the discharge amount. Further, the present embodiment facilitates disposing the pump portions 3A to 3E at the generally even intervals in the direction around the central axis O.

(13) The pump portions 3A to 3E (the first to fifth plunger pumps) overlap one another in the axial direction of the rotational driving shaft 300.

Therefore, the present embodiment can prevent or cut down the increase in the number of parts of the second unit 1B, thereby achieving the reduction in the size of the second unit 1B.

(14) The pump portions 3A to 3E (the first to fifth plunger pumps) each include the central axis 360 extending radially around the central axis O of the rotational driving shaft 300, and the straight line defined by extending the central axis 360 of the arbitrary pump portion 3A or the like beyond the central axis O of the rotational driving shaft 300 has the angle larger than zero degree in the direction around the central axis O of the rotational driving shaft 300 relative to the central axis 360 of another pump portion 3C, 3D, or the like.

Therefore, the present embodiment can reduce the pulse pressure.

(15) The brake system 1 includes the first unit 1A including the stroke simulator 6 configured to generate the reaction force of the brake operation performed by the driver, and the second unit 1B including the housing 8 including the fluid passages 11 and the like formed therein, the rotational driving shaft 300 provided inside the housing 8, and the plurality of pump portions 3A to 3E (plunger pumps) configured to be activated by the rotation of the rotational driving shaft 300 and disposed in the direction around the central axis O of the rotational driving shaft 300 inside the housing 8. The pump portions 3A to 3E are provided in such a manner that the number of pump portions positioned on the vertically lower side is larger than the number of pump portions positioned on the vertically upper side with respect to the central axis O of the rotational driving shaft 300 with the housing 8 mounted on the vehicle.

Therefore, the present embodiment can further effectively reduce the vibration of the second unit 1B in the brake system 1 in which the first unit 1A includes the stroke simulator 6.

### Second Embodiment

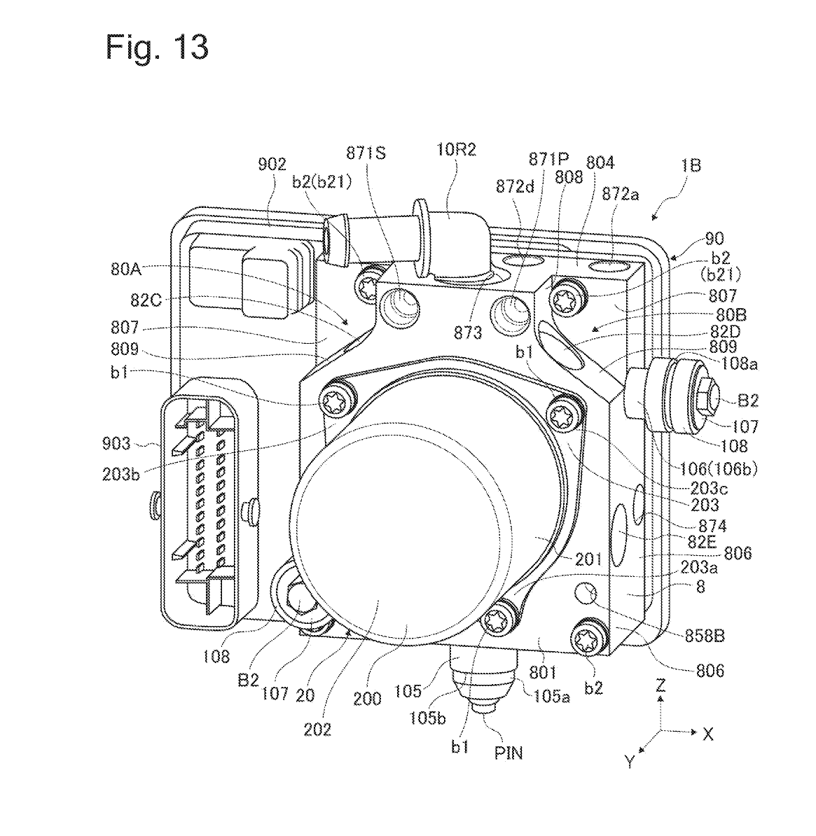

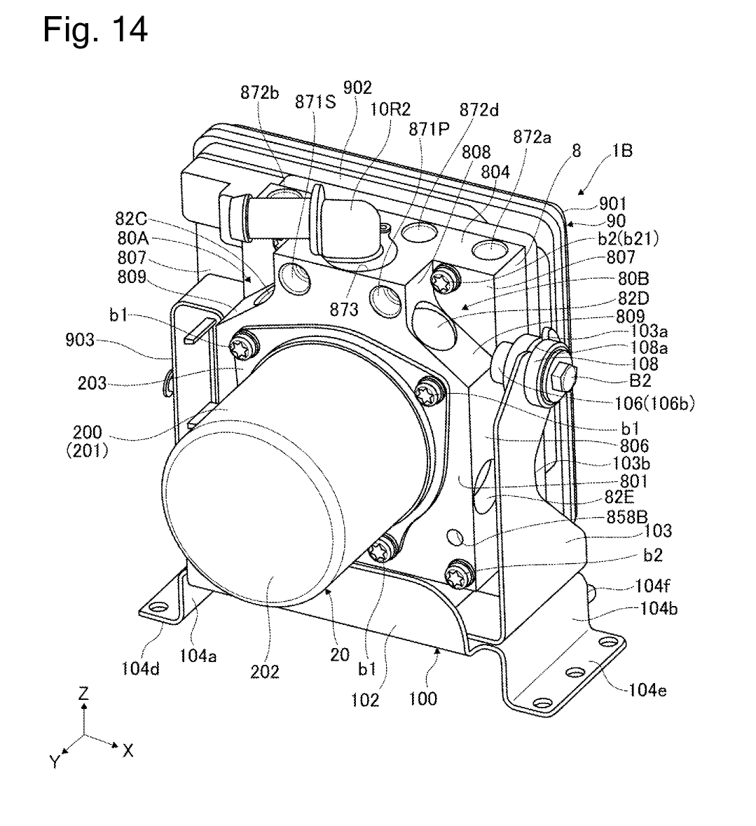

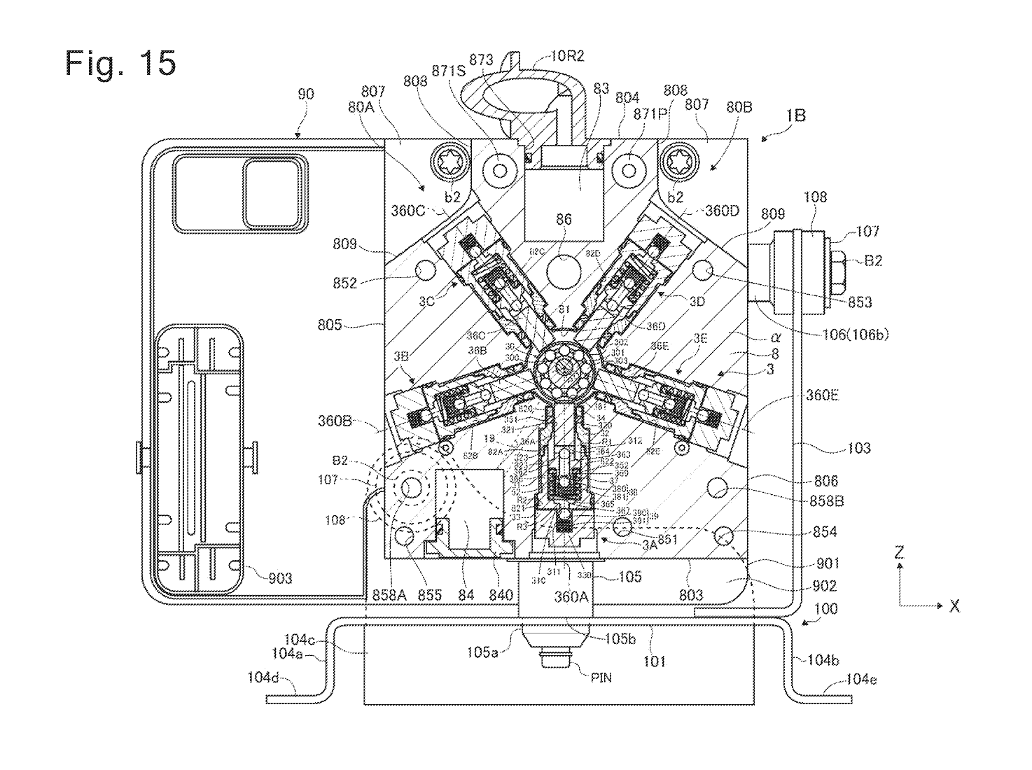

First, a configuration will be described. In the following description, a configuration shared with the first embodiment will be identified by the same reference numeral and a description thereof will be omitted. FIG. 13 is a perspective view similar to FIG. 8 that illustrates the second unit 1B according to the present embodiment with the pin PIN and the like attached thereto. FIG. 14 is a perspective view similar to FIG. 9 that illustrates the second unit 1B according to the present embodiment in the state installed on the mount 100. FIG. 15 is a front view similar to FIG. 10 that illustrates the second unit 1B according to the present embodiment in the state installed on the mount 100. No structure for supporting the housing 8 (the front surface 801) is provided on the X-axis positive direction side of the second mount portion 102. The mount 100 includes a third mount portion 103 provided integrally with the first mount portion 101 and the like. The third mount portion 103 is disposed generally in parallel with the Y axis and the Z axis. The third mount portion 103 extends from the end of the first mount portion 101 in the X-axis positive direction to the Z-axis positive direction side. A recessed portion 103a opened on the Z-axis positive direction side is formed at an end of the third mount portion 103 in the Z-axis positive direction. The bolt B2 is inserted in the recessed portion 103a. A Y-axis negative direction side of the third mount portion 103 includes a recessed portion 103b curved toward the Y-axis positive direction side. The bolt B2 of the third mount portion 103 is inserted and fixed in the bolt hole 858C of the housing 8. The bolt B2 fixes the right side surface 806 of the housing 8 to the third mount portion 103 via the insulator 108. The hole 858C functions as the fixation portion for fixing the housing 8 to the vehicle body side (the mount 100). The bolt B2, the collar member 106, and the washer 107 are the structure supporting the housing 8 (the right side surface 806), and function as the support portion of the right side surface 806. The other structure of the support portion on the third mount portion 103 is similar to the support portion on the second mount portion 102. The other configuration is similar to the first embodiment.

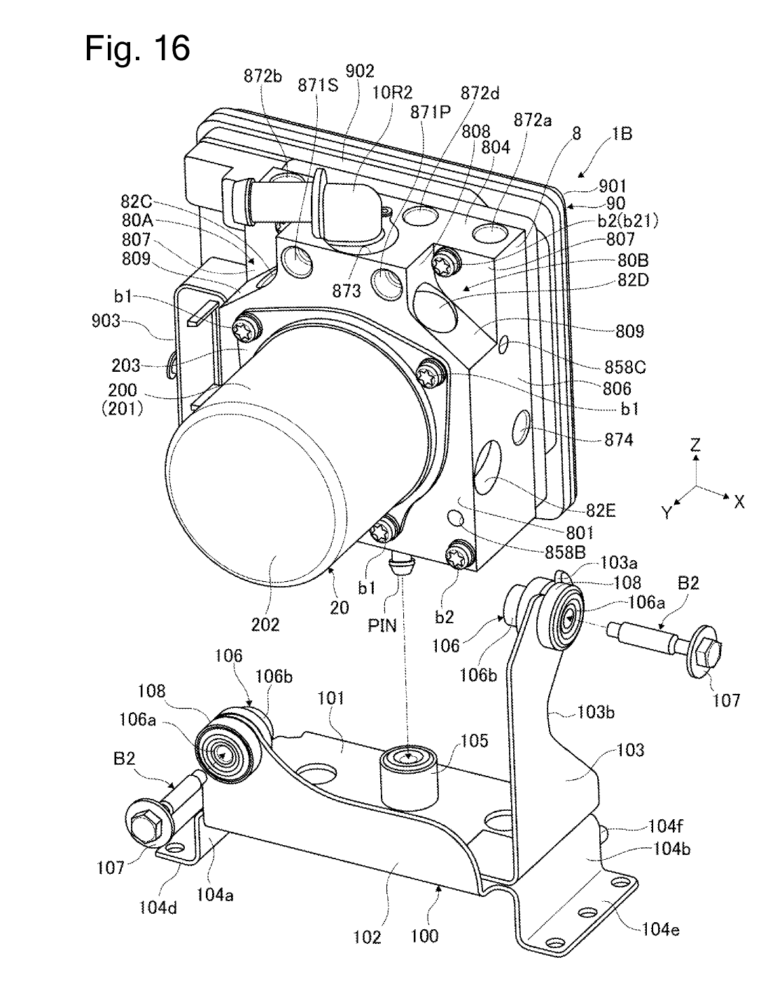

FIG. 16 is an exploded perspective view illustrating a process for attaching the second unit 1B onto the mount 100. In a first process, the insulator 108 and the collar member 106 are attached to the third mount portion 13. In a third process, the collar member 106 is sandwiched between the head portion (the washer 107) and the right side surface 806 and fixed to the right side surface 806 due to the axial force of the bolt B2. Other processes are similar to the first embodiment.

Next, functions and effects will be described. The hole 858C for the fixation to the mount 100 is provided on the right side surface 806 of the housing 8. Therefore, the present embodiment can efficiently utilize the side surface 806 of the housing 8 for the fixation to the mount 100 while avoiding the interference with the connector portion 903. The hole 858C extends horizontally, and the bolt B2 fixed in the hole 858C also extends horizontally. The support portion of the bottom surface 803, the support portion of the front surface 801, and the support portion of the right side surface 806 support the housing 8 in different directions from one another, whereby the present embodiment can improve support strength against the load that can be applied to the housing 8 in multiple directions. Further, the present embodiment can improve the effect of preventing or reducing the vibration against the vibration that can occur in the housing 8 in multiple directions. Further, the housing 8 is supported at the plurality of positions some distance away from one another in the direction around the central axis O, whereby the present embodiment effectively prevents or reduces the vibration of the second unit 1B in the direction around the central axis O. The holes 858A and 858B, and the hole 858C are disposed on both the opposite sides of the central axis O from each other in the Z-axis direction. Therefore, the present embodiment can further effectively reduce the vibration around the central axis O of the second unit 1B by supporting the housing 8 on the opposite sides of the central axis O from each other in the Z-axis direction. The center of gravity of the second unit 1B is positioned between the support portion of the right side surface 806 (the portion where the right side surface 806 is attached to the third mount portion 103) and the support portion of the bottom surface 803 (the portion where bottom surface 803 is attached to the first mount portion 101) in the Z-axis direction. The present embodiment can improve the strength of supporting the second unit 1B by supporting the second unit 1B on the opposite sides of the center of gravity from each other in the Z-axis direction. A straight line connecting the support portion and the support portion of the housing 8 becomes an axis when the housing 8 swings. A reduction in a distance between this axis and the behavior sensor leads to a reduction in an amplitude of the swing of the behavior sensor when the housing 8 vibrates, thereby contributing to preventing or reducing the deterioration of the detection accuracy of the behavior sensor. A straight line connecting the support portion of the right side surface 806 and the support portion of the bottom surface 803 becomes one of the above-described axes when the housing 8 swings. The hole 858C is provided on the vertically upper side of the right side surface 806. Therefore, the present embodiment facilitates disposing the above-described axis close to the behavior sensor. The backpressure port 874 is not covered by the third mount portion 103 due to the provision of the recessed portion 103b on the third mount portion 103, which facilitates the work of attaching the pipe 10X to the right side surface 806. Other functions and effects are similar to the first embodiment.

### Other Embodiments

Having described the embodiments for implementing the present invention with reference to the drawings, the specific configuration of the present invention is not limited to the embodiments, and the present invention also includes a design modification and the like thereof made within a range that does not depart from the spirit of the present invention.

In the following description, technical ideas recognizable from the embodiments will be listed.

(8) The hydraulic control apparatus described in the above-described item (6) further includes the control unit configured to contribute to the driving of the motor. The part of the bolt for attaching the control unit to the back surface protrudes in each of the first recessed portion and the second recessed portion.
(9) In the hydraulic control apparatus described in the above-described item (5), the housing includes the first fluid pool portion connected to the intake portion of each of the plurality of plunger pumps. The first fluid pool portion is disposed from the top surface into the housing, and is located between the two plunger pumps positioned on the vertically upper side in the direction around the central axis of the rotational driving shaft.
(10) In the hydraulic control apparatus described in the above-described item (5), the housing includes the second fluid pool portion configured to store therein the fluid leaking from the plurality of plunger pumps. The second fluid pool portion is disposed from the bottom surface into the housing.
(11) In the hydraulic control apparatus described in the above-described item (2), the plurality of plunger pumps is disposed at the generally even intervals in the direction around the central axis of the rotational driving shaft.
(16) In the hydraulic control apparatus described in the above-described item (15), the plurality of plunger pumps overlaps each other or one another in the axial direction of the rotational driving shaft.
(17) In the hydraulic control apparatus described in the above-described item (16), the plurality of plunger pumps each includes the central axis extending radially around the central axis of the rotational driving shaft, and the straight line defined by extending the central axis of arbitrary one of the plunger pumps beyond the central axis of the rotational driving shaft has the angle larger than zero degree in the direction around the central axis of the rotational driving shaft relative to the central axis of another one of the plunger pumps.

Having described merely several embodiments of the present invention, those skilled in the art will be able to easily appreciate that the embodiments described as the examples can be modified or improved in various manners without substantially departing from the novel teachings and advantages of the present invention. Therefore, such modified or improved embodiments are intended to be also contained in the technical scope of the present invention. The above-described embodiments may also be arbitrarily combined.

The present application claims priority under the Paris Convention to Japanese Patent Application No. 2015-194418 filed on Sep. 30, 2015. The entire disclosure of Japanese Patent Application No. 2015-194418 filed on Sep. 30, 2015 including the specification, the claims, the drawings, and the abstract is incorporated herein by reference in its entirety.

### REFERENCE SIGN LIST

1 brake system
1A first unit
1B second unit (hydraulic control apparatus)
11 supply fluid passage (fluid passage)
20 motor
3A pump portion (first plunger pump)
3B pump portion (second plunger pump)
3C pump portion (third plunger pump)
3D pump portion (fourth plunger pump)
3E pump portion (fifth plunger pump)
300 rotational driving shaft
360 central axis
8 housing
801 front surface (first surface)
802 back surface (second surface)
803 bottom surface (third surface)
804 top surface (fourth surface)
805 left side surface (fifth surface, first side surface)
806 right side surface (sixth surface, second side surface)
80A first recessed portion
80B second recessed portion

1. A hydraulic control apparatus comprising:
a housing including a fluid passage provided therein and configured to be mounted on a vehicle;
a rotational driving shaft provided inside the housing; and
a plurality of plunger pumps configured to be activated by a rotation of the rotational driving shaft and disposed in a direction around a central axis of the rotational driving shaft inside the housing, the plunger pumps being provided in such a manner that the number of plunger pumps positioned on a vertically lower side is larger than the number of plunger pumps positioned on a vertically upper side with respect to the central axis of the rotational driving shaft with the housing mounted on the vehicle.

2. The hydraulic control apparatus according to claim 1, wherein the plurality of plunger pumps overlaps each other or one another in an axial direction of the rotational driving shaft.

3. The hydraulic control apparatus according to claim 2, wherein the plurality of plunger pumps each includes a central axis extending radially around the central axis of the rotational driving shaft, and a straight line defined by extending the central axis of arbitrary one of the plunger pumps beyond the central axis of the rotational driving shaft has an angle larger than zero degree in the direction around the central axis of the rotational driving shaft relative to the central axis of another one of the plunger pumps.

4. The hydraulic control apparatus according to claim 3, wherein the plurality of plunger pumps includes two plunger pumps positioned on the vertically upper side and three plunger pumps positioned on the vertically lower side with respect to the central axis of the rotational driving shaft with the housing mounted on the vehicle.

5. The hydraulic control apparatus according to claim 4, wherein the housing includes
a front surface to which a motor coupled with the rotational driving shaft is attached,
a back surface opposite from the front surface,
a bottom surface connected to the front surface and the back surface and positioned on the vertically lower side with respect to the central axis of the rotational driving shaft with the housing mounted on the vehicle, and
a top surface opposite from the bottom surface, and
wherein at least one of the three plunger pumps positioned on the vertically lower side is disposed from the bottom surface into the housing.

6. The hydraulic control apparatus according to claim 5, wherein the housing includes
a first side surface connected to the front surface, the back surface, the bottom surface, and the top surface,
a second side surface opposite from the first side surface,
a first recessed portion opened on the front surface, the top surface, and the first side surface, and
a second recessed portion opened on the front surface, the top surface, and the second side surface, and
wherein one and the other of the two plunger pumps positioned on the vertically upper side are disposed from the first recessed portion and the second recessed portion into the housing, respectively.

7. The hydraulic control apparatus according to claim 6, wherein the three plunger pumps positioned on the vertically lower side are disposed from the bottom surface, the first side surface, and the second side surface into the housing, respectively.

8. The hydraulic control apparatus according to claim 6, further comprising a control unit configured to contribute to driving of the motor,
wherein a part of a bolt for attaching the control unit to the back surface protrudes in each of the first recessed portion and the second recessed portion.

9. The hydraulic control apparatus according to claim 5, wherein the housing includes a first fluid pool portion connected to an intake portion of each of the plurality of plunger pumps, and
wherein the first fluid pool portion is disposed from the top surface into the housing, and is located between the two plunger pumps positioned on the vertically upper side in the direction around the central axis of the rotational driving shaft.

10. The hydraulic control apparatus according to claim 5, wherein the housing includes a second fluid pool portion configured to store therein fluid leaking from the plurality of plunger pumps, and
wherein the second fluid pool portion is disposed from the bottom surface into the housing.

11. The hydraulic control apparatus according to claim 2, wherein the plurality of plunger pumps is disposed at generally even intervals in the direction around the central axis of the rotational driving shaft.

12. A hydraulic control apparatus comprising:
a housing, the housing including
a fluid passage and a rotational shaft provided therein,
a first surface,
a second surface opposite from the first surface,
a third surface connected to the first surface and the second surface,
a fourth surface opposite from the third surface,
a fifth surface connected to the first, second, third, and fourth surfaces,
a sixth surface opposite from the fifth surface,
a first recessed portion opened on the first, fourth, and fifth surfaces, and
a second recessed portion opened on the first, fourth, and sixth surfaces,
the housing being configured in such a manner that a motor coupled with the rotational shaft is attached to the first surface, and
the third surface is positioned on a vertically lower side with respect to a central axis of the rotational shaft and the first recessed portion and the second recessed portion are positioned on a vertically upper side with respect to the central axis of the rotational shaft with the housing mounted on a vehicle;
a first plunger pump disposed from the third surface into the housing and configured to be activated by a rotation of the rotational shaft;
a second plunger pump disposed from a portion of the fifth surface that is positioned on the vertically lower side with respect to the central axis of the rotational shaft with the housing mounted on the vehicle into the housing, the second plunger pump being configured to be activated by the rotation of the rotational shaft;
a third plunger pump disposed from the first recessed portion into the housing and configured to be activated by the rotation of the rotational shaft;
a fourth plunger pump disposed from the second recessed portion into the housing and configured to be activated by the rotation of the rotational shaft; and
a fifth plunger pump disposed from a portion of the sixth surface that is positioned on the vertically lower side with respect to the central axis of the rotational shaft with the housing mounted on the vehicle into the housing, the fifth plunger pump being configured to be activated by the rotation of the rotational shaft.

13. The hydraulic control apparatus according to claim 12, wherein the first to fifth plunger pumps overlap one another in an axial direction of the rotational shaft.

14. The hydraulic control apparatus according to claim 13, wherein the first to fifth plunger pumps each include a central axis extending radially around the central axis of the rotational shaft, and a straight line defined by extending the central axis of arbitrary one of the plunger pumps beyond the central axis of the rotational shaft has an angle larger than zero degree in the direction around the central axis of the rotational shaft relative to the central axis of another one of the plunger pumps.

15. A brake system comprising:
a first unit including a stroke simulator configured to generate a reaction force of a brake operation performed by a driver; and
a second unit including
a housing including a fluid passage formed therein,
a rotational driving shaft provided inside the housing, and
a plurality of plunger pumps configured to be activated by a rotation of the rotational driving shaft and disposed in a direction around a central axis of the rotational driving shaft inside the housing, the plunger pumps being provided in such a manner that the number of plunger pumps positioned on a vertically lower side is larger than the number of plunger pumps positioned on a vertically upper side with respect to the central axis of the rotational driving shaft with the housing mounted on the vehicle.

16. The hydraulic control apparatus according to claim 15, wherein the plurality of plunger pumps overlaps each other or one another in an axial direction of the rotational driving shaft.

17. The hydraulic control apparatus according to claim 16, wherein the plurality of plunger pumps each includes a central axis extending radially around the central axis of the rotational driving shaft, and a straight line defined by extending the central axis of arbitrary one of the plunger pumps beyond the central axis of the rotational driving shaft has an angle larger than zero degree in the direction around the central axis of the rotational driving shaft relative to the central axis of another one of the plunger pumps.
